(19) United States
(12) Patent Application Publication
(10) Pub. No.: US 2015/0081516 A1
(43) Pub. Date: Mar. 19, 2015

(54) METHOD AND SYSTEM FOR PRICING AND ALLOCATING SECURITIES

(71) Applicant: BUCKNELL TECHNOLOGIES PTY LTD, Woollahra (AU)

(72) Inventor: Benjamin George Wentworth BUCKNELL, Woollahra (AU)

(21) Appl. No.: 14/554,188

(22) Filed: Nov. 26, 2014

Related U.S. Application Data
(63) Continuation-in-part of application No. PCT/AU2013/000561, filed on May 30, 2013.

(30) Foreign Application Priority Data
May 31, 2012 (AU) 2012203237

(51) Int. Cl. G06Q 40/04

(52) U.S. Cl. CPC G06Q 40/04
USPC 705/37

(57) ABSTRACT

A method/system for pricing and allocating identified securities of a company on a registered securities exchange, as opposed to off-market. A host computer system or computer receives bid data indicative of one or more bids for the identified securities from one or more eligible investors. Determination of at least one price of the identified securities and a preferential allocation of at least some of the identified securities to eligible investors is performed at least partially based on bids that are higher than the determined match price or bids that are received prior to a specified time or times. The preferential allocation of at least some of the identified securities to at least some of the eligible investors is part of the bookbuild performed on the registered securities exchange. The bids are able to be accepted in real time by an issuer or seller of the identified securities.

### CROSS-REFERENCE TO RELATED APPLICATIONS

This application is a Continuation-in-Part of International Application PCT/AU2013/000561 filed May 30, 2013, which claims priority to AU Patent Application No. 2012203237 filed on May 31, 2012, the disclosures of which are incorporated in their entirety by reference herein.

### TECHNICAL FIELD

The present invention generally relates to a computer-implemented method of and system for pricing and allocating securities. Pricing and allocation of identified securities by a computer, host computer system or processor is part of a bookbuild that is performed on a registered securities exchange.

### BACKGROUND

Presently, already listed companies generally raise equity capital through one of the following described methods.

A “Pro Rata Offer” to all shareholders, which is not conducted via an exchange (i.e. a registered securities exchange), that is the offer is made “off-market”. The issuer sets a price at which new securities (e.g. shares) will be offered and each shareholder is entitled to apply for new securities, with entitlements determined pro rata by reference to their pre-offer shareholdings.

A “Share Purchase Plan”, which is also not conducted via an exchange, that is the offer is made “off-market”. The issuer invites shareholders to apply for an equal dollar value amount of new securities (e.g. shares) offered at the lower of a pre-specified price or price determined by a formula referencing the traded price of the securities since the announcement of the offer. Most jurisdictions limit the dollar amount which may be offered annually to each shareholder without shareholder approval (for example in Australia the limit is currently AU$15,000).

A “Placement”, which is again not conducted via an exchange, that is the offer is made “off-market”. Most jurisdictions permit securities to be issued on a non-pro rata basis without a prospectus to investors that satisfy a “sophisticated” or “professional” investor test. The process of pricing and allocating placements operates as follows:

i. bids are by invitation only and often only extended to institutional money managers—despite the law generally permitting much wider participation;

ii. the price at which new securities are issued may be fixed or may be established under an off-market process referred to as a “bookbuild”, which is generally conducted manually, and always subject to the discretion of the lead manager(s) and/or the issuer to determine pricing and allocations after all bids from prospective buyers have been received.

Under a bookbuild method, institutional money managers are invited to bid for various numbers of securities at various prices. Bids are collated off-market (i.e. not on a securities exchange) in a “book” maintained by a lead manager. The “book” is not publicly disclosed (i.e. bidders are not aware of the price and volume of other bidder's bids). The lead manager determines when the book is closed, then has discretion to:

i. set the price of new securities (usually in consultation with the issuer); and

ii. determine the amount (i.e. allocation) of new securities allocated to each bidder.

In most instances, the price is set at a discount to the pre-issue price and below the demand curve (i.e. at a price where there is more demand than supply) and each bidder's application is scaled back (usually not equally) at the discretion of the lead manager. This means that the price is artificially low, enhancing post-issue returns to successful bidders (at the expense of greater dilution to existing shareholders).

The discretionary, manual off-market bookbuild method is currently used for the issue of new shares for companies that are already listed (“private placements”), for the pricing and allocation of shares of unlisted companies when such companies list for the first time (an “Initial Public Offering”) and for the transfer of a number (usually a large holding) from one seller to a number of buyers (a “Sell-Down”).

In the reverse embodiment, companies may reduce their capital through offering to buy-back shares in the company through an off-market bookbuild by inviting shareholders to tender their shares at various asking prices. The company will then aggregate demand and buy-back shares that have been tendered at or below a certain price (determined by the lead manager after all tenders have been received). The buy-back shares are then typically cancelled by the company. The pricing and identification of successful bids is currently conducted by an off-market process where the match price is not calculated in real time, but rather at the end of the off-market bookbuild when all shares have been tendered.

The currently used bookbuild method causes various issues, for example a lack of fairness due to preferential treatment of certain shareholders or classes of investor through the capacity of the lead manager to exercise discretion. Also, in the currently used method there is an inability to identify and contact all potential eligible bidders to satisfactorily access all potential market demand to influence the price of new securities. Furthermore, in the currently used method there is an inability for investors or shareholders to increase (decrease) their bids in response to real time information and transparency as to the cumulative bids (asks) in the bookbuild process.

Reference to securities should be broadly read as any type of negotiable instrument representing financial value, including for example equity securities (such as common stocks, shares, derivative contracts) and debt securities (such as banknotes, bonds or debentures).

There is a need for a computer-implemented method, system and/or computer-readable storage medium having computer-executable instructions which addresses or at least ameliorates one or more problems inherent in the prior art.

The reference in this specification to any prior publication (or information derived from the prior publication), or to any matter which is known, is not, and should not be taken as an acknowledgment or admission or any form of suggestion that the prior publication (or information derived from the prior publication) or known matter forms part of the common general knowledge in the field of endeavour to which this specification relates.

In certain embodiments, the method includes
identifying, by the at least one computer and based on received data, at least one of the eligible investor's bids associated with a priority status; and
determining, by the at least one computer, the preferential allocation for at least some of the at least one eligible investor's bid based on the identified priority status.

In certain embodiments, the at least one computer has access to priority identifier data indicative of:

one or more identifiers indicative of the at least one eligible investor; and

the associated priority status;

wherein the method includes:

receiving, by the at least one computer, one of the bids having associated therewith the unique identifier for the at least one eligible investor; and

determining the priority status for the at least one eligible investor using the received unique identifier and the priority identifier data.

In certain embodiments, each priority status stored in the priority identifier data has associated therewith a priority factor for determining the preferential allocation, wherein the priority factor is defined by or on behalf of the company.

In certain embodiments, the one or more identifiers are one or more shareholder identifiers indicative of one or more current shareholders of the company.

### SUMMARY

According to one aspect, there is provided a computer-implemented method, system and/or computer-readable storage medium having computer-executable instructions for pricing and allocating identified securities as part of a bookbuild, which may be new securities (i.e. issued or unissued) or transferring an identifiable holding of existing securities of a company, or buy-back of existing securities, on a registered securities exchange.

According to another aspect, there is provided a computer-implemented method, system and/or computer-readable storage medium having computer-executable instructions for determining at least one price of identified securities as part of a bookbuild, which may be new securities (i.e. issued or unissued) or transferring an identifiable holding of existing securities, or buy-back of existing securities, on a registered securities exchange.

According to another aspect, there is provided a computer-implemented method, system and/or computer-readable storage medium having computer-executable instructions for an allocation of the identified securities, or transfer of the identifiable holding of existing securities, to one or more eligible investors, or buy-back (and possible cancellation) from tendering shareholders as part of a bookbuild on a registered securities exchange.

According to another aspect there is provided a computer-implemented method of pricing and allocating identified securities of a company. The method performed by at least one computer and comprising: allocating a unique trading code for the identified securities which are the subject of a bookbuild on a registered securities exchange; receiving, by the at least one computer which is associated with the registered securities exchange, bid data indicative of bids by eligible investors for at least some of the identified securities; determining, by the at least one computer, a match price for the identified securities after receiving at least some of the bid data; and determining, by the at least one computer, a preferential allocation of at least some of the identified securities to at least some of the eligible investors at least partially based on bids that are higher than the determined match price. The preferential allocation of at least some of the identified securities to at least some of the eligible investors is part of the bookbuild that is performed on the registered securities exchange.

According to another aspect there is provided a host computer system for pricing and allocating identified securities of a company, comprising: at least one processor to associate a unique trading code with the identified securities which are the subject of a bookbuild on a registered securities exchange; and, an input device to receive bid data indicative of bids by eligible investors for at least some of the identified securities. The at least one processor determines a match price for the identified securities after receiving at least some of the bid data, and a preferential allocation of at least some of the identified securities to at least some of the eligible investors at least partially based on bids that are higher than the determined match price. The preferential allocation of at least some of the identified securities to at least some of the eligible investors is part of the bookbuild that is performed on the registered securities exchange.

According to another aspect there is provided a computer-readable storage medium having computer-executable instructions for pricing and allocating identified securities of a company. The computer-executable instructions that when executed by at least one computer are configured to: associate a unique trading code for the identified securities which are the subject of a bookbuild on a registered securities exchange; receive bid data indicative of bids by eligible investors for at least some of the identified securities; determine a match price for the identified securities using at least some of the bid data; and determine a preferential allocation of at least some of the identified securities to at least some of the eligible investors at least partially based on bids that are higher than the determined match price. The preferential allocation of at least some of the identified securities to at least some of the eligible investors is part of the bookbuild that is performed on the registered securities exchange.

In a particular example, there is provided a computer-implemented method of pricing and allocating identified securities of a company on a registered securities exchange, including using at least one processing system or computer for performing the steps of: receiving one or more bids for the identified securities from one or more eligible investors; and, determining at least one price of the identified securities and an allocation of the identified securities to the one or more eligible investors. Preferably, the identified securities are new securities (i.e. issued or unissued) or an identifiable holding of existing securities in the case of a sell-down or buy-back.

In another particular example, there is provided a system for pricing and allocating identified securities of a company on a registered securities exchange, including one or more servers configured to: receive bid data indicative of one or more bids for the identified securities from one or more eligible investors; and, determine price data indicative of at least one price of the identified securities and allocation data indicative of an allocation of the identified securities to the one or more eligible investors.

In another particular example, there is provided a computer-implemented method of pricing and allocating, on a registered securities exchange, identified securities of a company, the method providing a bookbuild and comprising: allocating a unique trading code for the identified securities which are the subject of the bookbuild on the registered securities exchange; receiving, by a host computer system associated with the registered securities exchange, bid data indicative of bids by eligible investors for at least some of the identified securities; determining, by the host computer system, a match price for the identified securities after receiving at least some of the bid data; and determining, by the host computer system, a preferential allocation of at least some of the identified securities to at least some of the eligible investors at least partially based on bids that are higher than the determined match price.

In another particular example, there is provided a host computer system for pricing and allocating, on a registered securities exchange, identified securities of a company as part of a bookbuild, comprising: at least one processor to associate a unique trading code with the identified securities which are the subject of the bookbuild on the registered securities exchange; and, an input device to receive bid data indicative of bids by eligible investors for at least some of the identified securities; wherein, the at least one processor determines a match price for the identified securities after receiving at least some of the bid data, and a preferential allocation of at least some of the identified securities to at least some of the eligible investors at least partially based on bids that are higher than the determined match price.

According to another aspect, there is provided a computer-implemented method of pricing and allocating identified securities of a company on a registered securities exchange, the method providing a bookbuild and comprising: allocating a unique trading code for the identified securities on the registered securities exchange; receiving, by a host computer system, bid data indicative of at least one bid by an eligible investor for at least some of the identified securities; and, determining, by the host computer system, and at least partially based on the bid data, at least one price for the identified securities and an allocation of the identified securities to the eligible investor.

In various example forms: the preferential allocation is determined using a Price Leader's Allocation parameter; the Price Leader's Allocation parameter is a percentage of available securities; the preferential allocation is limited by a preferential allocation cap; and/or the Price Leader's Allocation parameter can be varied or is variable during the bookbuild.

Preferably, other allocations of at least some of the identified securities are based on: a priority allocation based on a priority status of a priority bidder; and/or, a pro rata allocation based on bids for a proportion of a number of securities. In various other example forms: the preferential allocation is allocated after the priority allocation; and/or the preferential allocation is allocated before the pro rata allocation. Optionally, the preferential allocation is determined using: surplus bids not filled in the priority allocation that are above the match price; and, all bids from on-market bidders that are above the match price. Optionally, the pro rata allocation is determined using: surplus bids not filled in the priority allocation and preferential allocation that are at or above the match price; and, all bids from on-market bidders that are at or above the match price.

In yet another example form, a Bid Price Limitation parameter is used to limit bids to within a specified range of the match price. In yet another example form, a Price Discovery parameter is used to limit bids used to determine the match price to bids within a specified range of the match price. In yet another example form, a Price Discoverer's Allotment parameter is used to at least partially allocate the identified securities to bids within a specified range of the match price. In yet another example form, an Institutional Buyer Price Discovery Enhancement parameter is used to limit bids that are taken into account for determining the match price and/or allocations. In yet another example form, a Lottery Allocation parameter is used to randomly allocate at least some of the identified securities. In yet another example form, a holding lock is used to prevent at least some securities from being sold for a period of time after being allocated under the bookbuild. This can be provided as an automated solution, for example providing a functional switch used to select between groups, rather than a discretionary application to individual allottees. A holding lock may be applied to an identified sub-set of the securities, selected either by lottery or by pro-rata allocation, to allottees that are allocated shares under one or more of the Priority Bid Allocation, the Price Leader's Allocation, the Price Discover's Allotment and/or the Institutional Buyer's Price Discovery Allotment.

In another example, other allocations of at least some of the identified securities are based on determining, by the at least one computer, a time-based allocation at least partially based on timing of submission of a bid. Optionally, a bidder who submits a bid prior to, at, or within, a specified or relative time or time period receives a time-based allocation. In another example, multiple time stages can be provided having different time-based allocations based on timing of submitting bids.

The allocation process optionally makes use of priority allocations (e.g. first priority allocations, second priority allocations), preferential allocations, time-based allocations, and/or pro rata allocations, either individually or in any combination or order. For example, Priority Bidder allocations or Early Bidder allocations may not be utilised in particular, though not necessarily preferred, examples.

According to another aspect, there is provided a host computer system for pricing and allocating identified securities of a company on a registered securities exchange, comprising: at least one processor to associate a unique trading code with the identified securities on the registered securities exchange; and, an input device to receive bid data indicative of at least one bid by an eligible investor for at least some of the identified securities; wherein, the at least one processor determines, at least partially based on the bid data, at least one price for the identified securities and an allocation of the identified securities to the eligible investor.

According to another aspect, there is provided a computer-readable storage medium having computer-executable instructions for pricing and allocating identified securities of a company on a registered securities exchange, the computer-executable instructions configured to: associate a unique trading code with the identified securities on the registered securities exchange; receive bid data indicative of at least one bid by an eligible investor for at least some of the identified securities; and, determine, at least partially based on the bid data, at least one price for the identified securities and an allocation of a number of the identified securities to the eligible investor.

According to another aspect, there is provided a computer-implemented method of determining at least one buy-back price for a company to purchase already issued company securities from a seller of the already issued company securities on a registered securities exchange, the method comprising: receiving, by a host computer system, offer data indicative of at least one offer by the company for at least some of the already issued company securities; and, determining, by the host computer system, and at least partially based on the offer data, the at least one buy-back price for the already issued company securities. Similarly to as previously discussed, a preferential offer can be determined of at least some of the already issued securities to at least some of the eligible sellers at least partially based on offers that are lower than the determined buy-back price. The preferential offer of at least some of the already issued securities to at least some of the eligible sellers is part of the bookbuild that is performed on the registered securities exchange.

Preferably, the computer-implemented method is performed in real time, for example so that the bids are able to be accepted in real time by an issuer or seller of the identified securities as part of the bookbuild performed on the registered securities exchange.

In yet another example form, determining the at least one price of the identified securities is at least partially based on a selection implemented in the at least one computer or host computer of: a total number of the identified securities; or a total value of the identified securities.

In yet another example form, determining the at least one price of the identified securities is at least partially based on a selection implemented in the at least one computer or host computer of: a single price to be determined for the identified securities; or different prices to be determined for the identified securities.

In yet another example form, the single price is determined by calculating when an excess of a total number of bids over a total number of identified securities to be issued is reached, or when an aggregated volume of bids remain unsatisfied after allocating the identified securities.

Preferably, the different prices are determined at least partially based on bids received from eligible investors.

In yet another example form, the single price is determined based on at least one parameter selected from the group consisting of: an excess coverage; a minimum price; a maximum price, a priority allocation for the eligible investor; an early bidder time-based allocation; and/or, a maximum value allocated to the eligible investor.

In yet another example form, the at least one price and the allocation are determined at least partially based on the further steps of: determining, by the at least one computer or host computer system, a match price satisfying the condition of an excess demand being equal to a pre-determined percentage over a supply; and, identifying, by the at least one computer or host computer system, if the at least one bid is equal to or in excess of the match price.

In yet another example form, the at least one price and the allocation are determined at least partially based on the further steps of: identifying, by the at least one computer or host computer system, if a bid is a priority bid and has been increased above the match price; and, allocating a percentage of the supply to the priority bid.

In yet another example form, an eligible investor identified from an off-market bookbuild is associated with a firm bid at a minimum price which conveys a priority status for the allocation of the identified securities if the firm bid is increased to the final match price.

In yet another example form, selecting whether a total number of the identified securities to be issued is fixed or is to be determined by a dollar value; selecting whether the identified securities are to be issued at a fixed price or at a number of different prices; and determining, by the at least one computer or host computer, the at least one price and the allocation.

In yet another example form, the allocation is: a Bid Driven Allocation based on an ordering of prices submitted under bids; or, a Pro-rata Driven Allocation based on bids for a proportion of a number of securities.

In yet another example form, if different prices are to be determined for the identified securities then the allocation is based on individual bid prices until: a total number of securities to be issued has been allocated; or there are no unsatisfied bids equal to or above a minimum price.

In yet another example form, the identified securities are existing securities and the method is for a buy-back or purchase of the existing securities, wherein the match price for the identified securities is equal to a pre-determined percentage over a fixed demand of the identified securities.

In yet another example form, determining the at least one buy-back price further includes: selecting whether a total number of the already issued company securities to be purchased by the company is fixed or is to be determined by a dollar value; and, selecting whether the already issued company securities are to be purchased by the company at a fixed price or at a number of different prices.

In yet another example form, identifying a successful seller is based on the determined buy-back price.

In yet another example form, the at least one buy-back price is above a price at which a cumulative supply is equal to a fixed demand for the already issued company securities.

In yet another example form, the at least one buy-back price is determined based on at least one parameter selected from the group consisting of: an excess coverage; a maximum price; a priority allocation; an early bidder time-based allocation; and/or, a maximum value allocation.

In yet another example form, an eligible seller identified from an off-market reverse bookbuild is associated with a firm ask at a maximum price which conveys a priority status for the buy-back of the securities if the ask is decreased to a final match price.

### BRIEF DESCRIPTION OF THE DRAWINGS

Example embodiments should become apparent from the following description, which is given by way of example only, of at least one preferred but non-limiting embodiment, described in connection with the accompanying figures.

FIG. 1 illustrates a flow diagram of an example computer-implemented method of pricing and allocating identified securities of a company or transferring existing securities by way of bookbuild on a registered securities exchange;

FIG. 2A illustrates a structure diagram of an example system for pricing and allocating a sub-set of a company's securities on a registered securities exchange;

FIG. 2B illustrates a structure diagram of another example system for pricing and allocating a sub-set of a company's securities on a registered securities exchange;

FIG. 3 illustrates a functional block diagram of an example processing system or computer that can be utilised to embody or give effect to a particular embodiment;

FIG. 4 illustrates an example network infrastructure that can be utilised to embody or give effect to a particular embodiment;

FIG. 5 illustrates a flow diagram of an example computer-implemented method of allocating securities by way of a bookbuild that uses priority bidder, price leader, early bidder and/or pro rata allocations, either individually or in any combination;

FIG. 6 illustrates a flow diagram of another example computer-implemented method of pricing and allocating securities by way of a bookbuild performed on a registered securities exchange that uses preferential allocation of at least some securities to at least some eligible investors; and

FIG. 7 illustrates a data structure for priority identifier data.

### DETAILED DESCRIPTION OF THE PREFERRED EMBODIMENTS

The following modes, given by way of example only, are described in order to provide a more precise understanding of the subject matter of a preferred embodiment or embodiments. In the figures, incorporated to illustrate features of an example embodiment, like reference numerals are used to identify like parts throughout the figures.

### Overview

In example embodiments there is provided a computer-implemented method of, system for, computer-readable storage medium having computer-executable instructions for, and/or computer program product for pricing and allocating securities. These embodiments can include, for example, where either: the cumulative supply of identified securities to be sold is to be determined via a bookbuild process and the demand is fixed or within a disclosed range (either in terms of a dollar value or a number of securities); or, the cumulative demand for identified securities to be issued is to be determined via a bookbuild process and the supply is fixed (either in terms of a dollar value or a number of securities).

Preferably, though not necessarily: a match price and eligible bids (eligible asks) are determined on a real time basis during, and not after, the bidding process; and, an allocation and/or pricing of identified securities, i.e. new or already issued existing securities, occurs on a registered securities exchange.

Identified securities should be read as a reference to new securities or an identifiable holding of existing securities. New securities may be issued or unissued securities. For example, in some countries (e.g. Australia) new securities such as shares are not issued at the time of a bookbuild. However, in some other countries (e.g. Canada and the United States of America) new securities such as shares may be issued prior to a bookbuild. Bids can include a bid price for securities and a bid volume of securities.

In a particular non-limiting example, the allocation and/or the pricing can be determined by:
calculating a ‘match’ price where the excess demand (excess supply) is equal to a pre-determined percentage over fixed supply (fixed demand) (e.g. 150%);
identifying all bids equal to or in excess (equal to or below) of the match price (“eligible bids”) (“eligible asks”);
optionally in certain iterations, identifying or determining all initial firm bids that have been increased (decreased) to the match price (“priority bids”) (“priority asks”);
allocating, optionally in certain iterations, a percentage, for example a pre-determined percentage, of supply to the priority bids (priority asks);
allocating, optionally in certain iterations, a percentage, for example a pre-determined percentage, of supply to the price leader bids (preferential asks);
allocating, optionally in certain iterations, a percentage, for example a pre-determined percentage, of supply to the early bidder bids (early bidder or time-based asks); and
allocating the remaining or otherwise unallocated shares on a pro-rata basis amongst the eligible bids (eligible asks).

For clarity, embodiments of the present invention are distinguished from, for example, methods and trading systems which facilitate the transfer of already issued securities between a seller and buyer of those securities, where a price is determined through matching supply and demand equally. In another example, there is also a distinction from methods for collating demand or supply of securities, whether issued or not, where the price and/or allocations are determined after all bids (on behalf of bidders or suppliers) have been received at the discretion of the issuer and/or lead manager.

In an example embodiment there is provided a method of pricing and allocating identified securities of a company, preferably though not necessarily a listed company, on a registered securities exchange, as opposed to an off-market bookbuild which presently occurs.

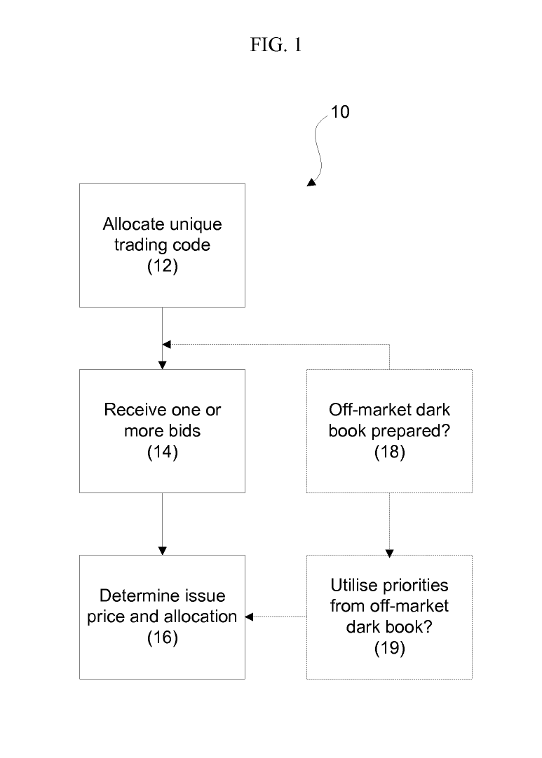

Referring to FIG. 1, there is illustrated a computer-implemented method 10 of pricing and allocating identified securities of a company on a registered securities exchange, which includes using at least one processing system, for example a host computer system or at least one computer. At step 12 a unique trading code is allocated for the identified securities to be priced and allocated via the registered securities exchange. At step 14 at least one bid is received by the host computer system for the identified securities from at least one client computer system used by or on behalf of at least one eligible investor. Subsequently, at step 16, at least one price of the identified securities can be determined by the host computer system and an allocation of the identified securities can be made to the at least one eligible investor. A bid by an eligible investor must include at least one bid price for securities and at least one bid volume of securities.

In one preferred form, the identified securities are new securities and the price is an issue price. In another preferred form, the identified securities are existing securities subject to a sell-down. Also preferably, the at least one price is less than a price at which a cumulative demand for the identified securities is equal to a fixed supply for the identified securities.

In a further example embodiment, pricing and allocating the identified securities on the registered securities exchange can be preceded by step 18 to produce an off-market bookbuild (i.e. “dark book”) which, if undertaken, can be subsequently followed by step 19 resulting in successful bidders from the off-market bookbuild having priority (for a limited percentage of their allocations from the dark book) in allocations in the on-exchange bookbuild. The allocations from the dark book can become the “opening firm bids” for the on-market bookbuild.

Novel methods/algorithms are utilised, preferably by the host computer system, to determine the at least one price and the allocation of the identified securities to potential investors. A plurality of different methods/algorithms for determining the price/allocation, by the host computer system, can be provided, with one or more specific methods/algorithms being chosen, for example by the issuer or lead manager, or automatically, to actually determine the final price(s) and allocation. Within each method/algorithm, a variety of parameters can be set/amended in the host computer system to reflect the issuer's or lead manager's preferences.

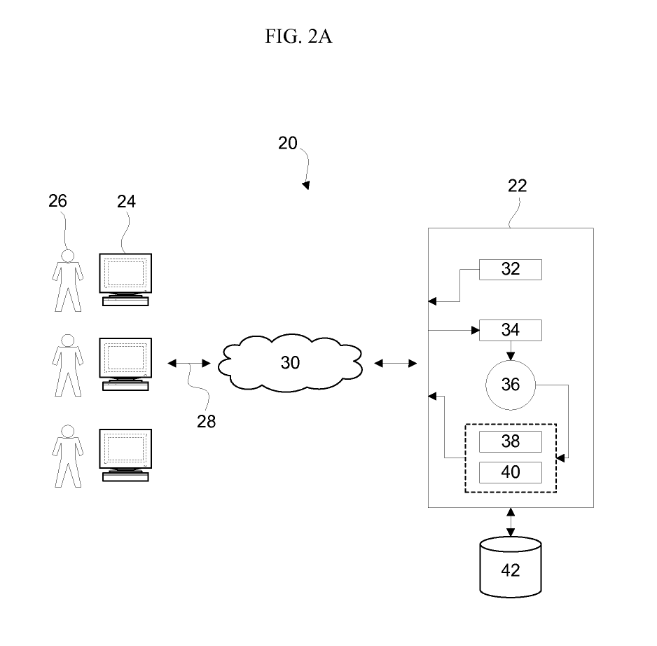

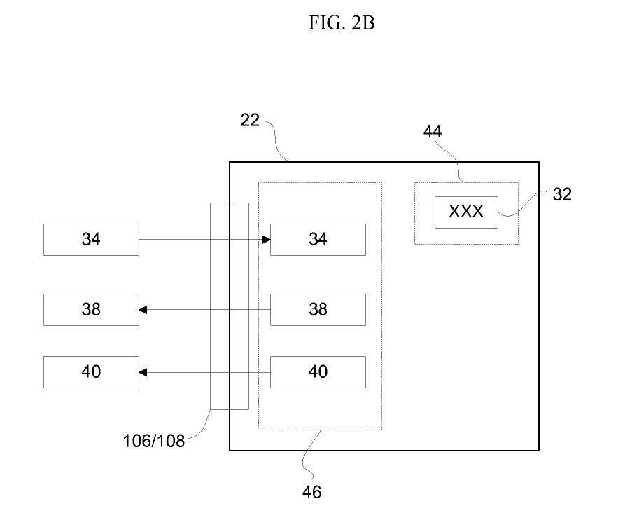

Referring to FIG. 2A, there is illustrated a system 20 for pricing and allocating identified securities of a company on a registered securities exchange. One or more securities exchange servers 22, i.e. the host computer system 22, provide at least one processing/host system on which method 10 can be performed. One or more terminals 24, i.e. at least one client computer system 24, can be used by or on behalf of at least one eligible investor 26 to send/receive data 28 to/from one or more exchange servers 22 via network 30. Determining if a person is an eligible investor can occur by a variety of ways, for example if the person verifies that they satisfy rules to be an eligible investor. Price data indicative of the at least one price and allocation data indicative of the allocation of the identified securities can be sent from the host computer system to at least one client computer system.

Exchange server(s) 22, i.e. the host computer system, allocate or associate a unique code 32 for identified securities, that may be actually selected by a human operator, which can be stored in or retrieved from database 42. A particular terminal 24, i.e. client computer system, receives unique code 32 to allow a particular eligible investor 26 to specify the identified securities of interest. Exchange server(s) 22 receive bid data 34 indicative of one or more bids from an eligible investor 26. Exchange server(s) 22 apply at least one algorithm 36 after receiving bid data 34. Price data 38, indicative of one or more prices, and allocation data 40, indicative of an allocation to the one or more eligible investors 26, are generated or produced using algorithm 36. Price data 38 and allocation data 40 can be communicated to or requested by terminals 24 via network 30. Data or information can be stored in and retrieved from database 42.

Software applications, modules and/or procedures can be used to provide functionality on the terminals 24 and exchange server(s) 22. Terminals 24 could be provided with a web browser or dedicated software application to interact with exchange server(s) 22. Functionality on the exchange server(s) 22 can be provided by dedicated programs, for example to implement algorithm 36 and associated parameters, and could utilise parts of existing software used on registered securities exchanges.

Referring to FIG. 2B, there is illustrated a host computer system 22 (or at least one computer) for pricing and allocating identified securities of a company on a registered securities exchange. The system 22 includes at least one processor so as to associate or allocate (automatically or based on manual input) a unique trading code 32 with the identified securities on the registered securities exchange. This process can be performed by software module 44. Input/Output device 106/108 is provided to receive bid data 34 indicative of at least one bid (e.g. including bid volume, bid price, bid time and/or conditional information such as a validity time) by an eligible investor for at least some of the identified securities. System 22 determines, at least partially based on the bid data 34, at least one price for the identified securities and an allocation of the identified securities to the eligible investor. The determining step can be provided by software module 46, which also calculates price data 38 indicative of the at least one price and allocation data 40 indicative of the allocation of the identified securities. Input/Output device 106/108 can then send price data 38 and allocation data 40 to at least one client computer system, for example being used by one or more eligible investors. Preferably, the determining steps and sending of data is performed in real time.

Software module 46 can determine at least one price of the identified securities at least partially based on a selection, either automated or manually effected, of a total number of the identified securities, or a total value of the identified securities. Software module 46 can also determine at least one price at least partially based on a selection, either automated or manually effected of a single price to be determined for the identified securities, or different prices to be determined for the identified securities.

Additionally, software module 46 can also determine a single price by calculating when an excess of a total number of bids over a total number of identified securities to be issued is reached, or when an aggregated volume of bids remain unsatisfied after allocating the identified securities. Different prices can be determined at least partially based on the bids received from eligible investors. Moreover, a single price can be determined by software module 46 based on at least one of the following parameters: an excess coverage; a minimum price; a maximum price; a priority allocation for the eligible investor; and/or, a maximum value allocated to the eligible investor.

Using software module 46, at least one price and an allocation can be further determined at least partially based on determining a match price satisfying the condition of an excess demand being equal to a pre-determined percentage over a supply, and identifying if the at least one bid is equal to or in excess of the match price. An allocation also can be determined at least partially based on determining if an opening bid has been increased to the match price so as to identify a priority bid, and allocating a percentage of the supply to such a priority bid, and whether a bid price is above, but not equal to the match price (a “Price Leader Bid”) and whether a bid price is entered prior to a specified time or specified times (an “Early Bidder's Bid”).

Software module 46 can additionally receive data indicating a priority status or level for an eligible investor. For example, an eligible investor can be identified from an off-market bookbuild as being associated with a priority status for the allocation of the identified securities.

Previously, when new issues of listed companies have been offered, such shares have been priced and allocated off-market and not via a securities exchange. Such shares have also previously been priced and allocated at the discretion of the issuer and/or lead manager and not according to pre-determined methods/algorithms. Also previously, the issuers and/or lead managers have not been able to select from a number of parameters to determine the pricing and allocation (i.e. to remove discretion from the pricing and allocation process after the bookbuild occurs).

Thus, according to various embodiments, it is advantageously provided for identified securities to be issued by way of placement to be priced and allocated as determined by methods/algorithms applied to bids made through a securities exchange. The commercial advantages include:

1. Expanding the number of bidders from invitation only by the lead manager to all eligible investors and the capacity for bidders to see real time match pricing results in improved pricing tension versus the current off-market, invitation only, zero price transparency process;

2. On-exchange bookbuilds enable corporate advisers to provide the lead manager's service effectively even where that corporate adviser's securities division does not have the leading market share in that issuer's securities;

3. Issuers and lead managers should face lower litigation threats as the allocations are determined by algorithmic rules rather than discretion;

4. The process is fairer, more equitable, more transparent and more inclusive than off-market bookbuilds for placements and IPOs and buy-backs;

5. The process addresses public concerns that investment banks are using their discretion in the allocation process to pay soft dollar brokerage to their trading clients, in conflict with the issuer's or seller's interest in attaining the highest (lowest) price for shares to be issued (bought-back) or transferred.

In a specific but non-limiting example, a registered securities exchange nominates a unique trading code to the securities to be issued or transferred and opens a bookbuild for identified securities. Bids for identified securities are restricted to investors who are eligible to bid under relevant laws. All eligible investors may lodge bids in the bookbuild for the identified securities. The final price and the allocation of securities is determined by at least one algorithm, which may be selected from a plurality of algorithms, and which can be agreed prior to the bookbuild, rather than pricing and allocations being determined at the discretion of the lead manager and/or issuer.

The issuer and/or lead manager can choose an algorithm for pricing of identified securities as either:

a single final price at which identified securities are issued, determined at the point that a pre-specified excess of total bids over total identified securities to be issued is reached or a specified aggregated volume of bids remain unsatisfied after the allocation process (“excess coverage”); or different prices for each identified security to be issued determined by the price of bids lodged by bidders (i.e. eligible investors, applicants, etc.).

If an algorithm is used to issue all identified securities at the same price, then various parameters can be specified in the algorithm to determine pricing of identified securities, including, for example:

the excess coverage used to determine the final price;

the minimum price at which identified securities may be issued if the excess coverage is not reached;

the maximum price at which identified securities may be issued;

priority for particular bidders which are identified as full priority bidders (first priority investors), who will receive 100% of their bid if it is above or equal to the match price (i.e. a first priority allocation to first priority bidders);

priority to a pre-specified percentage or number of bids at a minimum price (potentially allotted in a “dark pool”), if any, who also increase their bid to or above the final price, who will receive a pre-specified % of their bid if it is above or equal to the match price (second priority investors, i.e. a second priority allocation to second priority bidders);

priority to bidders whose final bid price is above, but not equal to, the final match price (“Price Leader Bids”) (i.e. a preferential allocation to price leader bidders);

priority to early bidders whose final bid price which is at or above the final match price (“Early Bids”) (i.e. an early bidder time-based allocation to early bidders);

any caps on the total value or shares which may be allocated to a bidder or the bidder's associates.

A dedicated software program(s), or alternatively a web based interface such as a browser or a mobile device or telephone app, could be used by an issuer or lead manager to set up and manage the identified securities offer on the host computer system, for example by selecting the desired algorithm(s) and setting the various parameters associated with specific algorithms to be applied by the host computer system. Server based applications can be used to implement pricing and allocating of the identified securities and to apply an algorithm to determine price(s) and an allocation of the identified securities. The algorithms are embodied as applied methods or in systems, preferably a computer-implemented method or processing system, and can be embodied as software applications, programs, procedures, modules, etc.

Preferably, the allocations determined by the on-market bookbuild constitute binding contracts. The identified securities to be issued may, or may not, be cleared through a clearing house.

Additionally, the method of issuing identified securities using a securities exchange may, or may not, be preceded by an invitation to institutional bidders to bid for the identified securities without disclosing other bids (i.e. “a dark pool”). A selected (discretionary) process can be used to determine priority allocations from the dark pool to create a “dark book” of successful bidders. If the on-exchange pricing does not result in a higher final price than the off-market dark book, then allocations from the dark book are binding (i.e. dark pool bids are irrevocable firm bids which become the opening and minimum price for the bookbuild). If the on-exchange pricing does result in a higher final price than the dark book, allocations from the dark book give successful bidders a right to increase their bid to match the final price.

If a successful dark book bidder exercises its right to match the final price:

(If) the securities offered in the dark book are included in the number offered in the on-exchange pricing and allocation—for successful bidders that increase their bids to the final price, priority in allocations from the on-market bookbuild in relation to a specified percentage of their allocations from the dark pool;

(If) the securities offered in the dark book are not included in the number offered on-market—for successful bidders that increase their bids to the final price, priority in allocations from the dark book in relation to a specified percentage of their allocations from the dark pool (which reflects the total number of securities issued through the on-market process rather than pursuant to the allocations made to participants in the dark pool).

The method may include an algorithm by which priority bidders enter a maximum price which the bidders would be willing to match (undisclosed to the market) where the match price increases. These bids could then automatically increase to the match price, up to the maximum. This means priority bidders would not miss out on increasing their bid if the match jumps just before close of the bookbuild.

### Processing System and Network

In a networked information or data communications system, a user (e.g. an eligible investor, bidder, applicant, etc.) has access to one or more client terminals which are capable of requesting and/or receiving information or data from local or remote information sources. In such a communications system, a client terminal may be a type of processing system, computer or computerised device, personal computer (PC), mobile, cellular or satellite telephone, mobile data terminal, portable computer, Personal Digital Assistant (PDA), pager, thin client, or any other similar type of digital electronic device. The capability of such a client terminal to request and/or receive information or data can be provided by software, hardware and/or firmware. A client terminal may include or be associated with other devices, for example a local data storage device such as a hard disk drive or solid state drive.

An information source can include one or more servers, such as a host computer system, or any type of terminal, that may be associated with one or more storage devices that are able to store information or data, for example in one or more databases residing on a storage device. The exchange of information (i.e., the request and/or receipt of information or data) between a client terminal and an information source (e.g. a securities exchange server or the host computer system), or other terminal(s), is facilitated by a communication means. The communication means can be realised by physical cables, for example a metallic cable such as a telephone line, semi-conducting cables, electromagnetic signals, for example radio-frequency signals or infra-red signals, optical fibre cables, satellite links or any other such medium or combination thereof connected to a network infrastructure.

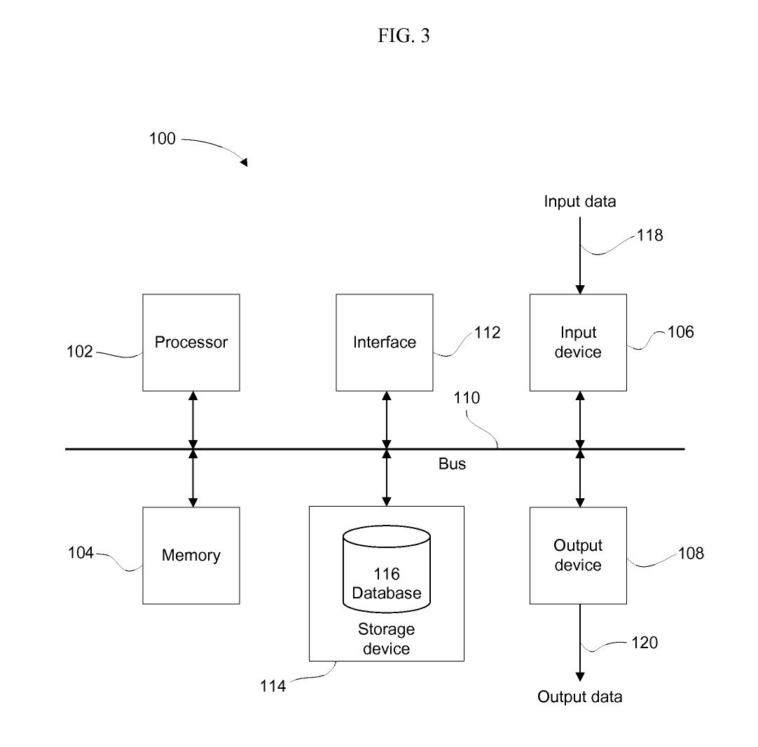

A particular example embodiment of the present invention can be realised using a processing system or host computer system, an example of which is shown in FIG. 3. In particular, the processing system 100, i.e. the host computer system, could be embodied as one or more servers providing a platform for a securities exchange. Processing system 100 (e.g. exchange server(s)) generally includes at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 can also be provided for coupling the processing system 100 to one or more peripheral devices, for example interface 112 could be a PCI card or PC card. At least one storage device 114 which houses at least one database 116 can be provided. The memory 104 can be any form of memory device, for example, volatile or non-volatile memory, solid state storage devices, magnetic devices, etc. The processor 102 could include more than one distinct processing device, for example to handle different functions within the processing system 100.

Input device 106 receives input data 118 (e.g. bid data 34 indicative of at least one bid, for example including a bid price and a bid volume, or a bid price range and/or a bid volume range) and can include, for example, a data receiver, network interface device, antenna such as a modem or wireless data adaptor, data acquisition card, etc. Input data 118 could come from different sources, for example keyboard instructions in conjunction with data received via a network. Output device 108 produces or generates output data 120 (e.g. price data 38 indicative of at least one price, and allocation data 40 indicative of the allocation of the identified securities) and can include, for example, a display device a data transmitter, network interface device, antenna such as a modem or wireless network adaptor, etc. Output data 120 could be distinct and derived from different output devices, for example a visual display on a monitor in conjunction with data transmitted to a network. A remote user could view data output, or an interpretation of the data output, on, for example, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, the at least one database 116. The interface 112 may allow wired and/or wireless communication between the processing unit 102 and peripheral components that may serve a specialised purpose. The processor 102 receives information or instructions as input data 118 via input device 106 and can display processed results or other output to a user by utilising output device 108. More than one input device 106 and/or output device 108 can be provided. It should be appreciated that the processing system 100 may be any form of terminal, server, specialised hardware, or the like.

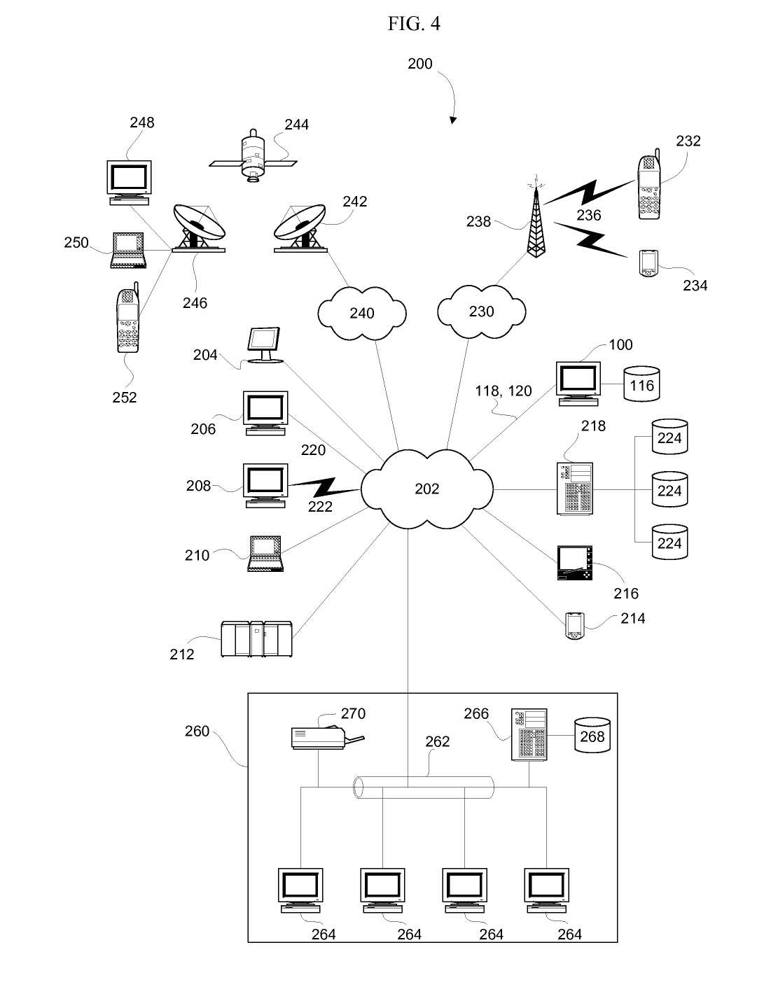

The processing system 100 may be a part of a networked communications system 200, as shown in FIG. 4. Processing system 100 could connect to network 202, for example the Internet or a WAN. Input data 118 and output data 120 could be communicated to other devices via network 202. Other terminals, for example, thin client 204, further processing systems 206 and 208, notebook computer 210, mainframe computer 212, PDA 214, pen-based computer 216, server 218, etc., can be connected to network 202. A large variety of other types of terminals or configurations could be utilised. The transfer of information and/or data over network 202 can be achieved using wired communications means 220 or wireless communications means 222. Server 218 can facilitate the transfer of data between network 202 and one or more databases 224. Server 218 and one or more databases 224 provide an example of an information source.

Other networks may communicate with network 202. For example, telecommunications network 230 could facilitate the transfer of data between network 202 and mobile or cellular telephone 232 or a PDA-type device 234, by utilising wireless communication means 236 and receiving/transmitting station 238. Satellite communications network 240 could communicate with satellite signal receiver 242 which receives data signals from satellite 244 which in turn is in remote communication with satellite signal transmitter 246. Terminals, for example further processing system 248, notebook computer 250 or satellite telephone 252, can thereby communicate with network 202. A local network 260, which for example may be a private network, LAN, etc., may also be connected to network 202. For example, network 202 could be connected with ethernet 262 which connects terminals 264, server 266 which controls the transfer of data to and/or from database 268, and printer 270. Various other types of networks could be utilised.

The processing system 100 is adapted to communicate with other terminals, for example further processing systems 206, 208, by sending and receiving data, 118, 120, to and from the network 202, thereby facilitating possible communication with other components of the networked communications system 200.

Thus, for example, the networks 202, 230, 240 may form part of, or be connected to, the Internet, in which case, the terminals 206, 212, 218, for example, may be web servers, Internet terminals or the like. The networks 202, 230, 240, 260 may be or form part of other communication networks, such as LAN, WAN, ethernet, token ring, FDDI ring, star, etc., networks, or mobile telephone networks, such as GSM, CDMA or 3G, etc., networks, and may be wholly or partially wired, including for example optical fibre, or wireless networks, depending on a particular implementation.

### Further Examples

### Algorithms for Calculating Final Price and Allocations

The following examples provide a more detailed discussion of particular embodiments. The examples are intended to be merely illustrative and not limiting to the scope of the present invention.

The lead manager and/or issuer select which one or more algorithms, for example embodied as software application modules, determine pricing and allocation by the host computer system and can then set the following parameters for the relevant algorithms.

Certain aspects of the present invention include process steps or instructions described in the form of an algorithm. It should be noted that the process steps or instructions of embodiments of the present invention could be embodied as a computer-implemented method, in software, firmware or hardware, and when embodied in software, could be downloaded to reside on and be operated from different platforms used by real time network operating systems.

The algorithms presented herein are not inherently related to any particular computer or other apparatus. Various computer systems may also be used with programs in accordance with the teachings herein, or it may prove convenient to construct more specialized apparatus to perform the required method steps. In addition, the present invention is not described with reference to any particular programming language. It is appreciated that a variety of programming languages may be used to implement the algorithms, process steps or instructions described herein.

### Pricing Examples

i. whether the number of identified securities which will be issued is fixed (Placement No#Securities Fixed) or to be determined by a dollar value represented by the price times the final price (Placement Value Fixed);
ii. whether all securities will be issued at the same price (Algorithm 1: Volume driven with single price) or at a number of different prices (Algorithm 2: Bid price driven with multiple prices);
iii. if Algorithm 1 is selected, whether Algorithm 1a or 1b will determine the final price:
   Algorithm 1a: the final price will be determined as being the highest price at which the percentage or number of total shares bid for is equal to or more than a pre-specified excess of bids over the number of identified shares (Target Excess Coverage At Match);
   Algorithm 1b: the final price will be first determined by the percentage or number of total shares bid for (asked for) over the number of identified shares (Total Target Excess Coverage Over Match);
   (collectively, Target Excess Coverage)
iv. the Target Excess Coverage percentage or amount;
v. the minimum price at which the issuer is willing to issue identified securities (Minimum Price);
vi. the maximum price at which the issuer is willing to issue identified securities (Maximum Price).

### Allocations Examples

i. the identity of any bidders whose bids are to receive an allocation of 100% of their bid (i.e. providing a priority allocation of at least some of the identified securities to at least some of the priority bidders/investors), provided such bid is above or equal to the final price, (First Priority Bidders) and the number of identified securities to which that priority relates (First Priority Allocations, i.e. a priority allocation);
ii. the identity of any bidders whose bids are to receive an allocation of a variable but specified % of their bid, provided such bid is above or equal to the final price, (Second Priority Bidders) and the number of identified securities to which that priority relates (Second Priority Allocations, i.e. a priority allocation);
iii. the identity of any bidders whose bids are to receive an allocation of a variable, and specified, but possibly undisclosed % of the remaining or otherwise unallocated shares, provided such bid is above, but not equal to, the final price, (Price Leader Bidders) and the number of identified securities to which that priority relates (Price Leader Allocations, i.e. a preferential allocation);
iv. the identity of any bidders whose bids are to receive an allocation of a variable, and specified, but possibly undisclosed % of the remaining or otherwise unallocated shares, provided such bid is received prior to a specified time, (Early Bidders) and the number of identified securities to which that priority relates (Early Bidder Allocations, i.e. a time-based allocation);
v. a cap (maximum) on bid size, including associates of the bidder, if any, expressed as a number of identified securities (Bid Caps), referable to one or more of the allocation stages;
vi. if Algorithm 1 is selected, whether Algorithm 1a—Target Excess Coverage At Match, or Algorithm 1b—Total Target Excess Coverage Over Match, is selected.

The price for each identified security is determined by an approach involving the use of conditional decision rules in real time as the bookbuild occurs. If a clear result cannot be achieved when the first decision rule is applied, the model progresses to a second decision rule and so on. The decision rules are preferably always applied in the same order.

Algorithm 1: Determining a Final Price above the Minimum Price and below the Maximum Price. Under Algorithm 1, all bids are filled at the same price regardless of the price actually stated when placing an order.

Principle 1: There are two steps involved in applying this principle. The first determines the cumulative bid quantities at each eligible price. The cumulative bid quantity increases as prices decrease—a buy price is the maximum that a buyer is willing to pay for their securities, however, it is accepted that the buyer is willing to pay a lower price. The second step determines a single final price, subject to the Maximum Price.

Step 1: Determining the number of securities to be issued. If the Placement No# Securities Fixed method is chosen, then that number of securities will be issued regardless of the price. If Placement Dollar Value Fixed method is chosen, the Placement Dollar Value Fixed is divided by each eligible price to determine the number of securities to be issued at that price.

Step 2: Determining the final price. The highest price above the Minimum Price and below the Maximum Price which causes: (a) if Algorithm 1(a) has been selected, the actual excess coverage to be greater than or equal to the Target Excess Coverage At Match; or (b) if Algorithm 1(b) has been selected, the unfilled quantity to be less than or equal to the Total Target Excess Coverage Over Match amount. The filled quantity at each price level is equal to Total Cumulative Bids—Identified Shares to be issued.

If Step 2 results in a price, then this becomes the official final price and the pricing process concludes. If the application of Principle 1, Step 2 does not result in a final price, then the algorithm moves to Principle 2 to determine a final price and to recalculate the number of securities to be issued.

Principle 2: Determining a Final Price at the Minimum Price. The final price is the Minimum Price and the number of securities to be issued to on-market bidders is reduced to the cumulative bids at that price.

Algorithm 1: Allocations are determined using the following principles.

Principle 3 (first priority allocations): First Priority Allocations at the Final Price are satisfied first.

Principle 4 (second priority allocations): Allocations to Second Priority Bidders, whose second priority bid volumes are multiplied by the Priority Allocation Percentage to determine the number of priority application securities for dark pool investors (Second Priority Shares). These investors receive next priority for up to the lesser of:
a) the Second Priority Shares; and
b) the number of shares for which the relevant Second Priority Bidder has lodged a bid at, or above, the Final Price.

Principle 5 (preferential allocations): Allocations to Price Leaders, to the extent that their bid volumes are above, but not equal to the match price, are multiplied by the Price Leader's Allocation Percentage to determine the number of Price Leader Allocation securities (Price Leader Shares). These investors receive next priority for up to the lesser of:
a) the Price Leader Shares; and
b) the number of shares for which the relevant Price Leader has lodged a bid above, but not equal to, the Final Price; and
c) the Price Leader Allocation Cap.

Principle 6 (time-based allocations): Allocations to Early Bidders, to the extent that their bidder volumes are received prior to a specified time, prior to a relative time, or within a specified time period or window, are multiplied by the Early Bidders Allocation Percentage to determine the number of Early Bidder Allocation securities (Early Bidder Shares). There can also be multiple specified or relative times, such as staged time cut-offs, with associated different time-based allocations or tiered time-based allocations. These investors receive next priority for up to the lesser of:
a) the Price Leader Shares; and
b) the number of shares for which the relevant Price Leader has lodged a bid above, but not equal to, the Final Price; and
c) the Early Bidder Allocation Cap.

Principle 7:

If Algorithm 1—Bid Driven Allocations has been selected, bids are satisfied, subject to any caps which have been specified, in order of the price submitted under the bid until the total number of securities allocated is equal to the number to be issued as calculated under Algorithm 1-Step 1. Any bids which have been allocated shares under an earlier principle are ignored to the extent of the allocation;

If Algorithm 1—Pro-rata Driven Allocations has been selected (pro-rata allocations), all bids equal to and above the final price are considered to be bids at the final price. Each bidder then receives an allocation in proportion to the number of securities bid for, subject to any caps which have been specified, until the total number of securities allocated is equal to the number to be issued as calculated under Algorithm 1, Principle 1-Step 1.

Algorithm 2: Bid price driven with multiple prices. Best priced bids have priority and identified shares are allocated at each selected bid price (which may be at or below the actual bid price at each selected price) until either:
a) the total number of securities to be issued has been allocated; or
b) there are no unsatisfied bids equal to or above the minimum price.

If there is more than one order at the same price, the order that was placed first takes precedence.

The following worked examples are intended to be merely illustrative and not limiting to the scope of the present invention.

### On-Market Bookbuilds

### Worked Example (a “Placement”, Target Excess Coverage at Match, Algorithm 1a, Pro-Rata Driven Allocations)

1. A company wishes to raise $100 m new equity. Its shares are trading at $1.00.
2. Some lead managers offer to use a method embodying the present invention to enhance their prospects of winning the mandate.
3. The company mandates a lead manager that offers to use the method to access the pricing and corporate governance benefits.
4. The lead manager and company agree that the ‘underwritten’ price is $0.85 (a 15% discount).
5. Provided at this point is an example of the previously known off-market process that is not conducted via a registered securities exchange (bid information is collated confidentially and disclosed only to selected clients, if any, at the discretion of the lead manager):
   a. The lead manager invites selected clients to bid for shares;
   b. The lead manager receives bids from 25 institutional clients to purchase 150 m of shares in total at 85 c. ($150 m) and bids from its retail client base of 12.5 m at the final price (a total of 165 m of bids);
   c. The lead manager calls each of the institutional bidders, explains the bidding interest in the book and tells the bidder that they will need to lift their bid to 86 c if they wish to receive an allocation;
   d. At 86 c, collectively, there are bids from 20 institutional bidders for a collective total of $109 m, and the $12.5 million of bids from retail client (i.e. $121.5 m in total);
   e. The lead manager (and issuer) exercise their discretion to determine that 86 c is an appropriate price and to determine allocations. For example, the lead manager may allocate $98 million to its institutional clients (90% of their bids) and $2 m to its retail clients (16% of bids).
   Nb. This would be where the previously known process ends, and $100 m of shares would be allotted to successful bidders at 86 c.
      The following points describe an example computer-implemented method according to the present invention.
6. Setting the Priority %'s: The Issuer/lead manager agree to set the First Priority Offer % to 60% and the Second Priority Bid % to 50%. Bidders who are in the First Priority Offer % group will receive allocations 100% of their bid (i.e. first priority allocations) and bidders who are in the Second Priority Bid % group will receive 50% of their bid (i.e. second priority allocations). Bidders only receive a priority allocation to the extent their bid has been increased to or above the final price.
7. The Issuer/lead manager has set the “Excess Coverage” to 150% and “Priority Allocation” to 50% (the Priority Allocations would need to have been disclosed in Step 5 to induce the bidders to bid).
The lead manager might use a similar process as Step 5 to decide who will be a Priority Bidder. These bids become the opening bids for the On-Market Bookbuild. These bids may be irrevocable at 85 c, and can be increased to the final price to receive a priority allocation.
8. On-Market Bookbuild commences and, with bidders able to see the match price, broader participation results in $150 m of bids at 95 c (match price).
9. At the close of the On-Market BookBuild:
   a. First Priority Offer bidders bid for 30 million shares at 95 c or above, and are allocated 30 million shares (100% of their bids at or above the final price);
   b. Second Priority Bid bidders bid for 29 million shares at 95 c or above, and are allocated 14.5 million shares (50% of their bids at or above the final price);
   c. 44.5 million shares have been allocated, leaving 55.5 million shares to be allocated;
10. Assume that the lead manager/issuer set the Price Leader's % at 50%, meaning Price Leaders will be allocated, 50% of the 55.5 million unallocated shares (i.e. 27.75 million shares). Second Priority Bidders may participate in this stage to the extent that their bids were not already filled, and to the extent that their bid price is above, but not equal to the match price. In total, 90.5 m bids meet this criteria, and they each receive, on a pro-rata basis, a preferential allocation of the 27.75 m shares. 72.25 m shares have now been allocated.
11. Assume that the lead manager/issuer set the Early Bidders % at 25% and the Early Bidder's Time at 11 am. This means that bidders that bid their final bid at a price above or equal to the match price prior to 11 am, to the extent unfilled by earlier allocation stages, will be allocated, pro rata, 25% of the 27.75 million unallocated shares (i.e. 6.9375 million shares). In total, 41.5 m bids meet this criteria, and they each receive, on a pro-rata basis, a time-based allocation of the 6.9375 m shares. 79.1875 m shares have now been allocated.
12. Remaining unsatisfied bids (including those equal to, but not above the match price, and those received after 11 am) receive allocations pro rata in respect of the volume of each bidders' bid at or above 95 c. In total, 70.8125 m bids meet this criteria, and they each receive their pro-rata allocation of the 20.8125 unallocated shares. The 100 m shares have now been allocated.

### On-Market Bookbuilds

### Worked Example (a “Buy Back”, Target Excess Coverage at Match, Algorithm 1a, Pro Rata Driven Allocations)

1. A company wishes to reduce its equity by $100 m. Its shares are trading at $1.00.
2. The company states that the buy-back price will be comprised of 80 c fully franked dividend (i.e. attaching a tax credit) and the remainder is a capital return.
3. To make the offer more attractive to shareholders, the company states that it will set a price based on where there is $150 m of shares tendered (i.e. 150% of supply).
4. The company opens an on-market bookbuild according to a method embodying the present invention.
5. Due to the attractiveness of the tax credit and the scale-back, shareholders tender shares below the trading price of $1.00.
6. As each shareholder can see the match price in real time, the shareholders can revise their asks downward to ensure that they can participate in the share buy-back (and receive the franking credit).
7. The company is able to purchase its shares back at a lower price than would otherwise be the case if the reverse bookbuild were carried out off-market without competitive tension. The company receives full value for the franking credits distributed.

### Further Examples

### Pricing and Allocations Including “Price Leader's Allocations” and “Early Bidder's Allocations”

The following examples provide a discussion of particular embodiments. The examples are intended to be merely illustrative and not limiting to the scope of the present invention. Presented are further examples for determining, by at least one computer, processor or system, a first priority allocation, a second priority allocation, a preferential allocation, a time-based allocation, a pro rata allocation, or levels or series of allocations, of at least some of the identified securities to at least some of the eligible investors. Preferably, preferential allocations are at least partially based on bids that are higher than the determined match price or received prior to a specified time.

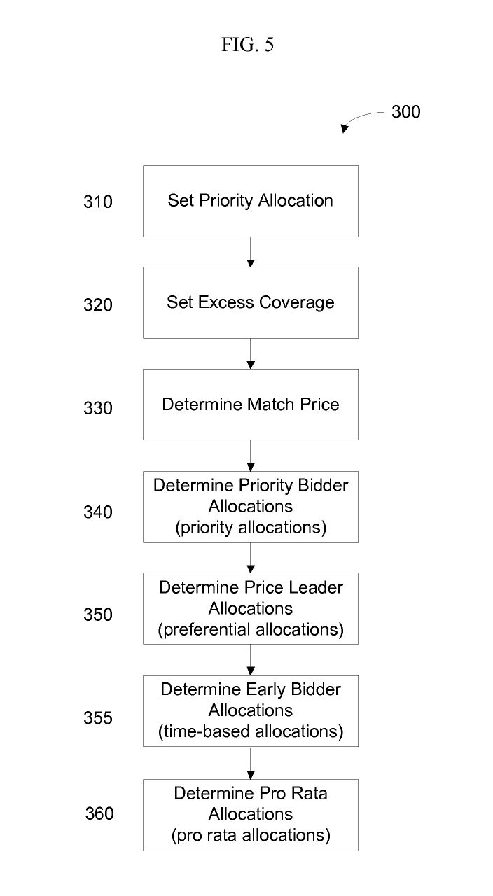

Referring to FIG. 5, there is illustrated a flow diagram of an example computer-implemented method 300 of allocating securities by way of a bookbuild that uses priority bidder, price leader, early bidder and/or pro rata allocations. Initially a lead manager(s) and, possibly, an underwriter(s) can be appointed. It should be noted that involvement of a lead manager(s) or an underwriter(s) are optional as an issuer, such as a company, could manage the bookbuild itself, subject to any rules imposed by the exchange that require a qualified or registered broker to operate the bookbuild facility. Assume a company (i.e. an issuer) wishes to raise capital by way of a placement and the company appoints a lead manager. The lead manager may, or may not, guarantee that the company will raise an agreed minimum amount at a minimum price per share (an underwriting). As a non-limiting illustrative example, assume that the company's shares were trading at $1.00 and the lead manager agrees to underwrite an issue of 100 million shares at $0.80 per share.

The lead manager (or any equivalent party) and/or issuer seeks “priority bids” for shares. A priority bid can be tagged or identified by a relevant securities exchange such as by using implementing software, and, if a priority bid is increased to, or above, a final match price, then the respective bidder is allocated a greater allocation of shares. There may be more than one level of priority bids, for example one level of priority bids may be guaranteed to receive 100% of their bid (i.e. a first priority allocation), another level of priority bids may be guaranteed to receive 75% of their bid (i.e. a second priority allocation) and yet another level may be guaranteed to receive 50% of their bid (i.e. a third priority allocation) and so forth. Every bid must be above the final price to realise its priority status and receive a priority allocation.

Referring to FIG. 5, at step 310 the lead manager and/or the issuer have discretion to set or vary, or not use at all, the “Priority Allocation” as they see fit for a particular placement, which can be expressed as a percentage (%), number, ratio, volume, etc. Each placement may have a different Priority Allocation, or no Priority Allocation. In a particular example, the Priority Allocation can be expressed as a percentage and referred to as the Priority Allocation %, and can vary between and including 0% and 100%. The Priority Allocation is preferably disclosed to the market. Also preferably, the Priority Allocation cannot be changed during the bookbuild process because on-market bidders will need to know how much of the placement is reserved for priority bidders.

Continuing the non-limiting illustrative example, assume: (a) the lead manager and company agree to set the Priority Allocation % to 50%; and (b) the lead manager accepts 100 million of priority bids and, in return, requires those bidders to submit irrevocable offers at $0.80. Any underwriter is now effectively “off risk” with no risk associated with a potential shortfall.

The lead manager (or any equivalent party) and/or issuer optionally seeks “early bids” for shares. An early bid, if utilised, can be tagged or identified by a relevant securities exchange such as by using implementing software, and, if an early bid is or above, or equal to, a final match price and received prior to a specified time, which may or may not be disclosed, then the respective bidder is allocated a greater allocation of shares. There may be more than one level of early bids, for example one level of early bids, received at 10 am, may receive 50% of the then unallocated securities (i.e. a first early bidder time-based allocation), another level of early bids, received at 11 am, may be guaranteed to receive 25% of the then unallocated securities (i.e. a second early bidder time-based allocation) and yet another level, received at 12 pm, may be guaranteed to receive 10% of the then unallocated securities (i.e. a third early bidder time-based allocation) and so forth. Alternatively, each bidder participating in an earlier bidder time-based allocation may be entitled to participate in later early bidder priority allocation stages. Every bid must be received prior to the relevant time for an early bidder time-based allocation that is specified to realise its time-based priority status and receive a time-based allocation.

After the bookbuild opens participants only see a match price and their own bids. The lead manager and/or issuer may see the entire book. Referring to FIG. 5, at step 320 the lead manager and/or the issuer set an “Excess Coverage”, which can be expressed as a percentage (%), number, ratio, volume, etc. In a particular example, the Excess Coverage can be expressed as a percentage and referred to as the Excess Coverage %. The Excess Coverage determines the match price. Each placement may have a different Excess Coverage %, of any value but subject to a minimum of 100%. The Excess Coverage can be changed during the bookbuild process by the lead manager and/or issuer to reflect or otherwise take into account the demand curve of the specific placement.

The Excess Coverage is preferably not disclosed to the market. Bidders should only bid for the maximum amount that the bidders are willing to bid for (as, depending on the variable parameters of each bookbuild, a bidder could end up with 100% of their bid). Continuing the non-limiting illustrative example, assume the lead manager and the issuer set the Excess Coverage % to 150%. This means the match price, determined at step 330, is determined as the price at which there is 150 million or more in cumulative bids. Each bidder at a bid price is assumed to be willing to acquire the securities at a lower price. At the end of the bookbuild, all shares are issued or sold at the final match price. Continuing the non-limiting illustrative example, assume there are total bids for 225 million shares at or above $0.90, with 150 million of bids at or above $0.95. The lead manager and the issuer might agree to close the book at this level. As such, $0.95 is the match price.

FIG. 5 illustrates allocation steps 340, 350, 355, and 360 that, in various examples, can be used individually or in any combination or order. To be clear, it is not necessary that each type of allocation step or process is utilised. The allocation process optionally makes use of priority allocations at step 340 (e.g. first priority allocations, second priority allocations), preferential allocations at step 350, time-based allocations at step 355, and/or pro rata allocations at step 360, either individually or in any combination or order. For example, Priority Bidder allocations or Early Bidder allocations may not be utilised in particular, though not necessarily preferred, examples.

TABLE I
Match Price Calculation

| | | | Total On- | Cumulative |
|---|---|---|---|---|
| | 1st | 2nd | Market Bids | Total Bids |
| Bid | Priority | Priority | at each Bid | at a Bid |
| Price | Bids | Bids | Price | Price |
| 1.00 | 0 | 0 | 0 | 0 |
| 0.99 | 0 | 6 | 21 | 27 |
| 0.98 | 7 | 7 | 22 | 63 |
| 0.97 | 8 | 8 | 21 | 100 |
| 0.96 | 8 | 4 | 14 | 126 |
| 0.95 | 7 | 4 | 13 | 150 |
| 0.94 | 7 | 4 | 10 | 171 |
| 0.93 | 7 | 3 | 7 | 188 |
| 0.92 | 6 | 1 | 7 | 202 |
| 0.91 | 6 | 1 | 6 | 215 |
| 0.90 | 4 | 2 | 4 | 225 |
| Total | 60 | 40 | 125 | |
| Match Price | 150 | m shares | | |
| target | | | | |

| | | |
|---|---|---|
| Point where | 0.95 | Note: refer to Cumulative |
| Excess Coverage | | Total Bids |
| ratio achieved | | |

Table I shows example data for a scenario continuing the non-limiting illustrative example. Referring to FIG. 5, at step 340, in a first allocation stage, securities, e.g. shares, are allocated to “First Priority Offer % Bidders” (i.e. first priority bidders) via a priority allocation. Bidders in the First Priority Offer bid group receive 100% of their bid (i.e. a first priority allocation), to the extent it is priced at or above the final match price.

Stage 1
Pro-rata Allocation

| | 1st | First |
|---|---|---|
| Bid | Priority | Priority |
| Price | Bids | Allocations |
| 1.00 | 0 | 0 |
| 0.99 | 0 | 0 |
| 0.98 | 7 | 7 |
| 0.97 | 8 | 8 |
| 0.96 | 8 | 8 |
| 0.95 | 7 | 7 |
| 0.94 | 7 | 0 |
| 0.93 | 7 | 0 |
| 0.92 | 6 | 0 |
| 0.91 | 6 | 0 |
| 0.90 | 4 | 0 |
| Total | 60 | 30 |

In a second allocation stage, priority allocations (i.e. a second priority allocation) are made to “Second Priority Bid % Bidders” (i.e. second priority bidders) determined by, in one example, multiplying the Priority Allocation % (in this example it is 50%) by the number of the second priority allocation bids that have been increased to or above the match price. On-market (only) bidders do not participate in priority allocations. There may be multiple priority allocation stages, however in this example there are only two: First Priority Offer % Bidders (who receive 100% of their bid as a priority allocation), and Second Priority Bid % Bidders (who receive the specified %, in this example, 50%, of their bids as a priority allocation). In other examples three or more priority allocation stages can be provided, for allocation stages to first priority bidders, second priority bidders, third priority bidders, etc.

| | Stage 2 | | |
|---|---|---|---|
| | Priority Allocation | | |
| | Second | | |
| | Priority | Second | % of Priority |
| Bid | Allocation | Priority | Bids Filled |
| Price | Bids | Allocations | by Stage 1 |
| 1.00 | 0 | 0.0 | 0% |
| 0.99 | 6 | 3.0 | 50% |
| 0.98 | 7 | 3.5 | 50% |
| 0.97 | 8 | 4.0 | 50% |
| 0.96 | 4 | 2.0 | 50% |
| 0.95 | 4 | 2.0 | 50% |
| 0.94 | 0 | 0.0 | 0% |
| 0.93 | 0 | 0.0 | 0% |
| 0.92 | 0 | 0.0 | 0% |
| 0.91 | 0 | 0.0 | 0% |
| 0.90 | 0 | 0.0 | 0% |
| Bid Price | 29 | 14.5 | |

At step 350, in a third or further allocation stage, securities, e.g. shares, are preferentially allocated to “price leaders” (i.e. at least some of the eligible investors) as preferential allocations. A price leader bid is a bid that is higher than the match price. A match price has been determined for the identified securities after receiving the bid data. A preferential allocation of at least some of the identified securities to at least some of the bidders can then be determined at least partially based on received bids that are higher than the match price. The lead manager and/or the issuer set:
(a) “Price Leader's Allocation”. The Price Leader's Allocation (i.e. the preferential allocation) is a variable parameter and can be expressed as a percentage (%), number, ratio, volume, etc. In a particular example, the Price Leader's Allocation can be expressed as a percentage and referred to as the Price Leader's Allocation %. The lead manager and/or the issuer decide upon a percentage (%), number, ratio, volume or amount of the securities that have not been allocated (i.e. the total offer size less the shares allotted to priority bidders in the first stage), which may be allocated in this stage to the price leaders (optionally subject to a Price Leader's Allocation Cap, discussed below). This percentage (%), number, ratio, volume, or amount is referred to as the Price Leader's Allocation.
(b) “Price Leader's Allocation Cap”. This optional cap is used by the lead manager and/or the issuer to limit the total allocation that a bidder can receive under this step as a price leader:
   i) but not as a result of allocations from priority allocations (first stage discussed above) or pro rata allocations (fifth stage discussed below). That is, the cap preferably only applies to the allocations made to individual bidders during the price leader allocation stage. The cap allows the lead manager and/or the issuer to “set and forget” the parameters at the beginning of the bookbuild to achieve the desired allocation split between price leaders and bidders at the match price (if desired).
   ii) including as a result of allocations from priority allocations (first and second stages discussed above) or pro rata allocations (last stage discussed below). The cap allows the lead manager and/or the issuer to “set and forget” the parameters at the beginning of the bookbuild to ensure that no bidder receives more than a specified percentage of their bid having regard to all stages of participation.

| | Stage 3 | | | | |
|---|---|---|---|---|---|
| | Price Leaders Allocation | | | | |
| | | Priority | | | % of Price |
| | Price | Bidder | On-Market | Price Leader | Leader |
| Bid | Leader | Stage 3 | Bidder Stage 3 | Allocation | Bids Filled |
| Price | Bids | Allocation | Allocation | Total | by Stage 2 |
| 1.00 | 0.0 | 0.0 | 0.0 | 0.0 | 0% |
| 0.99 | 24.0 | 0.9 | 6.4 | 7.4 | 31% |
| 0.98 | 25.5 | 1.1 | 6.7 | 7.8 | 31% |
| 0.97 | 25.0 | 1.2 | 6.4 | 7.7 | 31% |
| 0.96 | 16.0 | 0.6 | 4.3 | 4.9 | 31% |
| 0.95 | 0.0 | 0.0 | 0.0 | 0.0 | 0% |
| 0.94 | 0.0 | 0.0 | 0.0 | 0.0 | 0% |
| 0.93 | 0.0 | 0.0 | 0.0 | 0.0 | 0% |
| 0.92 | 0.0 | 0.0 | 0.0 | 0.0 | 0% |
| 0.91 | 0.0 | 0.0 | 0.0 | 0.0 | 0% |
| 0.90 | 0.0 | 0.0 | 0.0 | 0.0 | 0% |
| | 90.5 | 3.8 | 23.9 | 27.75 | |

c) “Early Bidder's Allocation”. Referring to FIG. 5, at step 355, the Early Bidder's Allocation (i.e. a time-based allocation) is a variable parameter and can be expressed as a percentage (%), number, ratio, volume, etc. In a particular example, the Early Bidder's Allocation can be expressed as a percentage and referred to as the Early Bidder's Allocation %. The lead manager and/or the issuer decide upon a percentage (%), number, ratio, volume or amount of the securities that have not been allocated (i.e. the total offer size less the shares allotted to the First Priority Bidders in the first stage, Second Priority Bidders in the second stage and Price Leader's in the third stage), which may be allocated in this fourth stage to the Early Bidders (optionally subject to a Early Bidder's Allocation Cap, discussed below). This percentage (%), number, ratio, volume, or amount is referred to as the Early Bidder's Allocation.
(b) “Early Bidder's Allocation Cap”. This optional cap is used by the lead manager and/or the issuer to limit the total allocation that a bidder can receive under this step as an early bidder either:
   i) not as a result of allocations from priority allocations or price leaders allocation (first, second and third stages discussed above) or pro rata allocations (last stage discussed below)). That is, the cap preferably only applies to the allocations made to individual bidders during the early bidder allocation stage. The cap allows the lead manager and/or the issuer to “set and forget” the parameters at the beginning of the bookbuild to achieve the desired allocation split between early bidders and bidders that bid later in the process (if desired); or
   ii) including as a result of allocations from priority allocations or price leaders allocation (first, second and third stages discussed above) or pro rata allocations (last stage discussed below)). The cap allows the lead manager and/or the issuer to “set and forget” the parameters at the beginning of the bookbuild to ensure that no bidder receives more than a specified percentage of their bid having regard to all stages of participation.

| | Stage 4 | | | | | |
|---|---|---|---|---|---|---|
| | Early Bidders Allocation | | | | | |
| | | | | Early | | % of |
| | | | Early | Bidder | | Early |
| | Eligible | Eligible | Bidder | Allocations | Early | Bidder |
| | 2nd | On- | Allocations | to On- | Bidder | Bids |
| Bid | Priority | Market | to Priority | Market | Allocations | Filled by |
| Price | Bids | Bids | Bidders | Bidders | Total | Stage 4 |
| 1.00 | 0.0 | 0.0 | 0.0 | 0.0 | 0.0 | 0% |
| 0.99 | 1.6 | 7.3 | 0.3 | 1.2 | 1.5 | 17% |
| 0.98 | 1.8 | 7.6 | 0.3 | 1.3 | 1.6 | 17% |
| 0.97 | 2.1 | 7.3 | 0.3 | 1.2 | 1.6 | 17% |
| 0.96 | 1.0 | 4.9 | 0.2 | 0.8 | 1.0 | 17% |
| 0.95 | 1.5 | 6.5 | 0.3 | 1.09 | 1.3 | 17% |
| 0.94 | 0.0 | 0.0 | 0.0 | 0.0 | 0.0 | 0% |
| 0.93 | 0.0 | 0.0 | 0.0 | 0.0 | 0.0 | 0% |
| 0.92 | 0.0 | 0.0 | 0.0 | 0.0 | 0.0 | 0% |
| 0.91 | 0.0 | 0.0 | 0.0 | 0.0 | 0.0 | 0% |
| 0.90 | 0.0 | 0.0 | 0.0 | 0.0 | 0.0 | 0% |
| | 8.0 | 33.5 | 1.3 | 5.6 | 6.9 | |

Each placement may have a different Priority Bidder's Cap, Price Leader's Allocation Cap and Early Bidder's Allocation Cap. These parameters can be changed during the bookbuild process by the lead manager and/or the issuer to reflect views on how much price leaders should be rewarded and the shape of the demand curve. Preferably, the Price Leader's Allocation and Price Leader's Allocation Cap and Early Bidder's Allocation Cap (if used) are not disclosed to the market. The Price Leader's Allocation encourages bidders to bid (for the actual number of shares that they wish to be allocated, rather than a larger amount in expectation of a particular scale-back) at the maximum price that they are willing to pay. As mentioned above, under Algorithm 1, all shares are issued at the same match price (a bidder does not pay a higher price as a result of lodging a higher bid).

Referring back to the third stage of the allocation process, securities are preferentially allocated to price leaders. Price leaders are at least some of the eligible investors that provide bids that are above (and preferably not equal to) the match price. Bids considered in this stage include:
surplus bids from priority bidders not filled in the priority allocation that are above the match price;
all bids from on-market bidders that are above the match price.

The total Price Leader's Allocation is preferably determined as the minimum of:
the Price Leader's Allocation % multiplied by the remaining unallocated number of securities (after priority bids have been allocated); and
the total number of price leader's bids.

Continuing the non-limiting illustrative example, assume the lead manager and/or the issuer have set the Price Leader's Allocation % to 50%. This means that there are 27.75 million shares to be distributed pro-rata amongst the price leader bids (100 million available shares less priority allocations of 30 million to First Priority Bidders, less 14.5 million to Second Priority Bidders, being 55.5 million, multiplied by 50%). The 27.75 million is allocated pro-rata to price leaders (i.e. their price leader bid as a % of total price leader bids) but is subject to any Price Leader's Allocation Cap. If the Price Leader Allocation (as determined above) to the bidder is greater than the allocation under the cap set by the lead manager and/or the issuer (i.e. Price Leader Allocation Cap % multiplied by price leader individual bid), then the amount determined under the cap is the allocation. That is, the allocation is the minimum of: the shares available as a result of allocating the shares from the price leader's allocation pool pro rata to price leaders; and each individual price leader bid multiplied by the Price Leader Allocation Cap. In this example, the Price Leader's Allocation Cap is not triggered.

The total Early Bidder's Allocation is preferably determined as the minimum of:
a) the Early Bidder's Allocation % multiplied by the remaining or otherwise unallocated number of securities (after priority and/or price leader bids have been allocated); and
b) the total number of Early Bidder's bid; and
c) the Early Bidder's Allocation Cap.

Continuing the non-limiting illustrative example, assume the lead manager and/or the issuer have set the Early Bidder's Allocation % to 25% and the specified Early Bidder Time to 11 am. This means that there are 6.9375 million shares to be distributed pro-rata amongst the Early Bidder bids to the extent that they have not already been allocated in prior stages (100 million available shares less priority allocations of 44.5 million, less the allocations to Price Leaders of 27.75, leaving 27.5 million, which is multiplied by 25%). The 6.9375 million is allocated pro-rata to early bidders (i.e. their early bidder bid as a % of total early bidder bids) but is subject to any Early Bidder's Allocation Cap. If the Early Bidder's Allocation (as determined above) to the bidder is greater than the allocation under the cap set by the lead manager and/or the issuer (i.e. Early Bidder's Allocation Cap % multiplied by i) early bidder's total bid or ii) by the volume of a bidder's bid that would, but for the cap, be otherwise eligible to be considered in the early bidder's allocation stage; then the amount determined under the cap is the allocation. That is, the allocation is the minimum of: the shares available as a result of allocating the shares from the Early Bidder's pool pro rata to early bidders; and each individual early bidder's bid multiplied by the Early Bidder's Cap. In this example, the Early Bidder's Allocation Cap is not triggered.

Referring to FIG. 5, at step 360, in a fifth allocation stage, the remaining unissued securities are determined and distributed via a Pro Rata Allocation to all bids equal to, or above, the match price. Bids considered in this stage include:
surplus bids from both stages of priority bidders not filled in the Priority Allocation phases, the Price Leader's Allocation and the Early Bidder's Allocation that are at, or above, the match price; and
all bids from on-market bidders not filled by the Price Leader's Allocation or the Early Bidder's Allocation that are at, or above, the match price.

Continuing the non-limiting illustrative example, assume the pro rata allocation consists of 20.8125 million shares (100 million available shares less 30, less 14.5, less 27.75, less 6.9375). The remaining shares are allocated pro rata to remaining bids (determined as an individual bidder's unfilled bids at or above the match price as a percentage of all unfilled bids at or above the match price).

Stage 4
Final Allocation

| | | Pro rata | Pro rata | Pro rata | | | |
|---|---|---|---|---|---|---|---|
| | | allocations | allocations | allocations | | | |
| | | to 2nd | to 2nd | to | | | % of |
| | | Priority & | Priority | On-Market | On-Market | | Pro Rata |
| | | Early | Non-Early | Early | Non-Early | Pro-rata | Bids Filled |
| Bid | Final Stage | Bidders | Bidder | Bidder | Bidder | Allocation | by Pro |
| Price | Bids | Allocation | Allocation | Allocations | Allocation | Total | Rata Stage |
| 1.00 | 0.0 | 0.0 | 0.0 | 0.0 | 0.0 | 0.0 | 0% |
| 0.99 | 15.2 | 0.4 | 0.2 | 1.8 | 2.1 | 4.5 | 29% |
| 0.98 | 16.1 | 0.4 | 0.2 | 1.9 | 2.2 | 4.7 | 29% |
| 0.97 | 15.8 | 0.5 | 0.2 | 1.8 | 2.1 | 4.6 | 29% |
| 0.96 | 10.1 | 0.3 | 0.1 | 1.2 | 1.4 | 3.0 | 29% |
| 0.95 | 13.7 | 0.4 | 0.1 | 1.6 | 1.9 | 4.0 | 29% |
| 0.94 | 0.0 | 0.0 | 0.0 | 0.0 | 0.0 | 0.0 | 0% |
| 0.93 | 0.0 | 0.0 | 0.0 | 0.0 | 0.0 | 0.0 | 0% |
| 0.92 | 0.0 | 0.0 | 0.0 | 0.0 | 0.0 | 0.0 | 0% |
| 0.91 | 0.0 | 0.0 | 0.0 | 0.0 | 0.0 | 0.0 | 0% |
| 0.90 | 0.0 | 0.0 | 0.0 | 0.0 | 0.0 | 0.0 | 0% |
| | 70.8 | 2.0 | 0.8 | 8.2 | 9.9 | 20.8 | |

As a result of the allocation stages detailed above, each bidder group has been provided with a fair allocation of shares under the offer, with those parties that participate as priority bidders, price leaders or early bidders being rewarded with a higher percentage of their bids being filled in each respective allocation stage. Those bidders that were below the match price when the book was closed receive zero allocation. Continuing the non-limiting illustrative example, Table II shows example final allocations as a percentage of bidders final bid volume when the bookbuild is closed.

Allocation as a % of Total Bid by Bidder Group

| | |
|---|---|
| 1st Priority Bidders | 100% |
| 2nd Priority & Price Leader & Early Bidder | 80% |
| 2nd Priority & Price Leader, & Not Early Bidder | 76% |
| 2nd Priority, Not Price Leader, & Early Bidder | 71% |
| 2nd Priority, Not Price Leader, & Not Early Bidder | 65% |
| On-Market, & Price Leader, & Early Bidder | 59% |
| On-Market, & Price Leader, & Not Early Bidder | 51% |
| On-Market, Not Price Leader, & Early Bidder | 41% |
| On-Market, Not Price Leader, Not Early Bidder | 29% |

### Table II

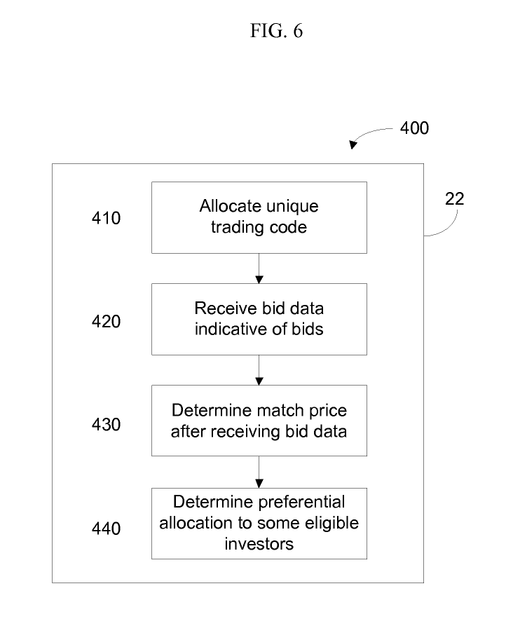

Referring to FIG. 6 there is illustrated a flow diagram of another example computer-implemented method of pricing and allocating securities by way of a bookbuild performed on a registered securities exchange that uses preferential allocation of at least some securities to at least some eligible investors. There is shown a computer-implemented method 400 of pricing and allocating identified securities of a company. The method 400 is performed by at least one computer 22. Computer-implemented method 400 includes, at step 410, allocating a unique trading code for the identified securities, which are the subject of the bookbuild on the registered securities exchange. At step 420, bid data is received by the at least one computer 22 which is associated with the registered securities exchange, the bid data indicative of bids by eligible investors for at least some of the identified securities. At step 430, the at least one computer 22 determines a match price for the identified securities after receiving at least some of the bid data. At step 440, the at least one computer 22 determines a preferential allocation of at least some of the identified securities to at least some of the eligible investors, preferably at least partially based on bids that are higher than the determined match price and at least partially based on bids, that are equal to or higher than the determined match price, and bids received before a specified time. The preferential allocation of at least some of the identified securities to at least some of the eligible investors is part of the bookbuild that is performed on the registered securities exchange.

### Further Examples

### Various Embodiments

The following examples provide a discussion of further various embodiments. The examples are intended to be merely illustrative and not limiting to the scope of the present invention.

Bid Price Limitation:

This relates to a variable parameter that limits bid entry prices, within a variable, but specified, range of the match price.

Example: an issuer/lead manager could specify that all bids must be within a specified range of the match price. The bookbuild system would not permit bids outside of this range to be entered. The purpose is to ensure that bids that are not reasonable in terms of price expectations of the issuer/lead manager cannot be entered into the auction and to prevent any potential to distort pricing. Bids that are outside of the specified range do not participate in allocations.

Price Discovery Enhancement:

This relates to a variable parameter that limits the bids that are taken into account for the purposes of calculating the match price, within a variable, but specified, range of the match price. The purpose is another method to ensure that bids that are not reasonable in terms of price expectations of the issuer/lead manager can be entered into the auction, but do not distort pricing, while allowing the issuer to see those bids, when making its pricing decision and allocating securities. Bids that are outside of the specified range do participate in allocations, despite not influencing price.

Example: an issuer/lead manager could specify that bids that were more than, for example, 10% (or 10 c) more than the match price are ignored for the purpose of “Excess Coverage”, which is a factor used to determine the match price. The purpose is to ensure that bids that are not sensibly contributing to true price discovery (as judged by the issuer/lead manager) are ignored for the purpose of calculating match price. This limits the influence of bidders that bid high to achieve a bid “at the final price”, rather than at a price that represents their actual view of a fair price.

Price Discoverer's Allotment:

This relates to a variable parameter that provides for a specified percentage (%), number, ratio, volume, etc., of the, at that time, unallocated securities to be allocated to bids within a variable, but specified, range of the match price (“On-Market Price Discoverers”).

Example: an issuer/lead manager could specify that 80% of the securities that have not been allocated to priority bids, are allocated to price leader bids (or all bids at or above the match price) that are within, for example, 10% of the match price. The purpose is to offer a reward, in terms of greater allocations, to bidders that contribute to the price discovery process and to discourage bids that are price insensitive (“at final bids”).

Institutional Buyer Price Discovery Enhancement:

This relates to a variable parameter, specified as a minimum size bid (either in terms of currency or share volumes), that limits those bids that are taken into account for the purposes of: calculating the match price; and/or making allocations (“Institutional Buyer Price Discoverers”).

Example: an issuer/lead manager could specify that only bids of more than, for example, $1 million or 1,000,000 securities are considered for the purpose of the “Excess Coverage”, which is used to calculate the match price. The purpose of using this variable parameter would be where the issuer/lead manager believes that bids of a certain size are more instructive in price discovery than bids of a smaller size, possibly reflecting an increased ability of the bidder to make a better assessment of fair value.

Example: an issuer/lead manager could specify that only bids of, for example, more than $1 million or 1,000,000 securities are considered for the purpose of allocations. The purpose would be to ensure that a capital raising attracts an institutional investor base, rather than a retail investor base, which some issuers may consider desirable in some circumstances.

Lottery Vs Scale-Back Allocation Parameter:

This relates to a variable parameter whereby allocations can be made on either a “lottery” or “scale-back method” (if scale-back, employing, to the extent specified, the different allocations for priority bidders, price leaders, on-market price discoverers and institutional buyer price discoverers). This allows a Lottery Allocation parameter to be applied to randomly allocate at least some of the identified securities, such as by partially allocating securities using randomly generated amounts.

Example: if the number of bids at the match price are very large, and the number above the match price very small, the issuer may be constrained in decreasing the Excess Coverage (and increasing the match price). The issuer/lead manager may view that the scale back would disenfranchise bidders, and consequently, a lottery system may result in a more favourable outcome. The random nature of the lottery ensures that the process remains fair to all bidders. Moreover, by having the selected method as a variable parameter which is undisclosed to the market, bidders may be discouraged from deliberately overbidding volumes (with the expectation of scale back) as such bidders could receive 100% of their bid (and have to pay for their entire bid volume).

Long-Term Investor's Enhancement:

This relates to the imposition of one or more “holding locks” that prevents the holder of securities from selling for a period of time, or times, a variable, but specified percentage, or percentages, of the securities acquired under the bookbuild, applied, according to a variable but specified parameter, that determines if the holding lock, or locks are applied. For example:
a) By way of pro-rata application to all allocations;
b) By way of “lottery” to certain allocations; or
c) On specified tranches of allocations to priority bidders, price leaders, early bidders, on-market price discoverers and institutional buyer price discoverers.

Example: an issuer/lead manager could specify that a registered securities exchange put a “holding lock” (which prevents the securities from being traded on the exchange) on the securities as follows (by way of example):
a) 33% without holding lock;
b) 33% for 1 month holding lock; and
c) 33% for 3 months holding lock.

The issuer/lead manager could specify that each tranche of securities could be allocated pro-rata amongst allocations, or alternatively, by lottery amongst successful allottees. Alternatively, the issuer/lead manager may specify that successful allottees receive securities with the following holding locks (by way of example):
a) Priority Bidder allocations or early bidders—no holding lock;
b) Price Leaders' allocations—1 month holding lock;
c) On-Market Price Discoverers or Institutional Buyer Price Discoverers allocations—2 months holding lock;
d) On-Market Bidder allocations—3 months holding lock.

The existence of this variable parameter may discourage speculative bidding that may interfere with an orderly market and encourage bidding from longer-term investors.

Time Priority:

Another priority stage or stages can be provided in relation to the timing of when bidders submit bids. Time-based allocations can be formulated similarly to the Price Leaders allocation, for example as a % of the “then unallocated” part of the offer. For example, referring to FIG. 5, at step 355 early bidder allocations can be determined by the at least one computer, based on timing of submission or receipt of bids. Time-based priority or preferential allocations can be provided to bidders who enter or submit their bid prior to a specified or relative time or times (or series of allocation priorities, based on a series of times). For example, time-based allocations could be calculated and allocated based on a set time period or series of periods (e.g. time cut-offs) before a given deadline, such as closing of the offer, so that earlier bidders are given a priority status. In another example, time-based allocations could be calculated and allocated based on relative timing of bids from different bidders, such as if a first bidder submits a bid at least a given or specified time period earlier than a second bidder submits a bid, then the first bidder may be given a priority status over the second bidder. Thus, other allocations of at least some of the identified securities can be based on determining, by the at least one computer, a time-based allocation which is at least partially based on timing of submission of a bid or bids. There can also be provided multiple early bidder stages receiving different time-based allocations, for example bids received before 10 am, then 11 am, etc., could receive different early bidder time-based allocations based on timing of submitting bids.

### Underwriter's Allotment

Another last allocation stage or stages can be provided in relation to underwriter's that have agreed, for example as described above, that have agreed to purchase a minimum number of securities to the extent that other bidders do not submit bids. Each underwriter's bid would be satisfied after all other bids and on a pro-rata basis as between the underwriter's bid.

### Unique Identifiers Indicative of Priority Status

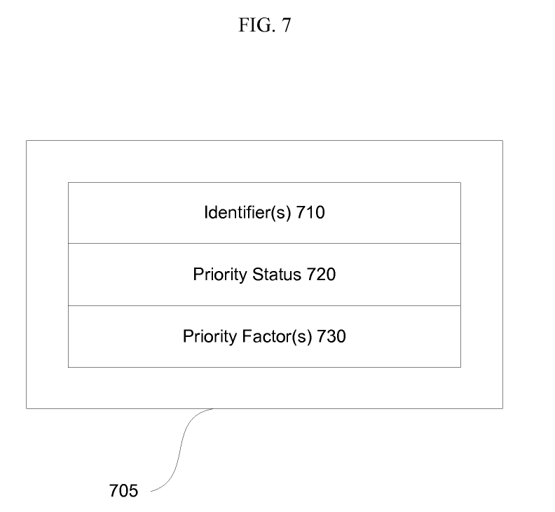

Referring to FIG. 7, in certain embodiments, the lead manager can store in memory of the host processing system priority identifier data 705. In particular, the priority identifier data 705 includes a plurality of unique identifiers 710 each of which are associated with an eligible bidder who has been offered priority status. For example, the priority identifier data 705 a plurality of unique identifiers 710 where each unique identifier is indicative of a current shareholder of a company. In this instance, the lead manager uploads company shareholder register data to the host processing system with pre-allocated unique identifiers 710. Additionally or alternatively, unique identifiers 710 indicative of desired eligible investors which are currently non-shareholders may be stored in the priority identifier data 705. Eligible investors who have been included in the priority identifier data 705 are informed, potentially via electronic communication via the host processing system, of the identifier 710 that has been stored to identify the respective eligible investor. As will be discussed below, bids which are received which wish to take advantage of the priority status 720 can be indicative of the unique identifier 710 for the eligible investor such that the host processing system can determine the preferential allocation for the respective eligible bidder.

The lead manager can additionally store in memory a priority allocation factor 73—which is associated with each priority status 720. For example, a first predefined priority factor 730 may be stored in memory and associated with each identifier 710 having a priority status 720 indicating the eligible investor is a current shareholder. A second predefined priority factor 730 may stored in memory and associated with each identifier 710 having a priority status indicative of the eligible investor being a desired preferred investor. For example the Lead Manager can specify a certain amount of priority for unique identifiers, for example shareholder identifiers, having a particular priority status 720. This would allow, for example, an issuer via its lead manager, to provide priority to its own shareholders for amounts equal to their proportionate holding in the company, if they are willing to pay the final match price.

When a bid is placed via the host processing system by an eligible investor or on behalf of the eligible investor by their respective broker via a client processing system, the bid data can include identifier data input by the user placing the bid. In particular, the identifier data is indicative of the unique identifier associated with the eligible bidder who has been provided a priority status. Upon receipt of the bid data, the host processing system searches the priority identifier data 705 using the identifier indicated by the identifier data to determine whether the eligible bidder has a priority status 720 and if so what type of priority status has been recorded and more specifically what predefined priority allocation factor 730 has been associated with the type of priority status 720 for the eligible bidder.

The use of the priority identifier data 705 is particularly advantageous as a bid does not have to entered by the lead manager to have priority status 720. A bid can be entered by any broker, provided it is associated with the unique identifier.

In particular embodiments, the balance for an eligible bidder having priority status according to the priority allocation factor 730 can be treated by the host processing system as a non-priority bid.

An example is now provided below for further clarity. A Listed Company (“Listco”) wishes to raise new equity of $100 million. Its shares are currently trading at $1.00. To motivate investors to provide the new equity, it needs to offer the new shares to investors at a discount. It also wishes to offer shareholders the opportunity not to be diluted, if they are willing to pay a price at or above the price at which the new shares will be issued (effectively a pre-emptive right).

ListCo is advised by a lead manager (“Technical Lead Manager” or “TLM”), that will operate the parameters to the bookbuild facility that will determine pricing, allocation and enter any priority bids from new investors that ListCo may consider desirable to have on its shareholder register.

Prior to the bookbuild facility opening, the TLM obtains the shareholder register. It enters each unique shareholder identifier into the bookbuild facility with the corresponding percentage holding of that shareholder in ListCo.

The bookbuild facility opens with a minimum price of 90 c. ListCo notifies each shareholder, or their broker, that bids from shareholders that are at or above the final bookbuild price, will be afforded priority status to the extent of their percentage holding in the company. Priority status means that the bids will be allocated shares prior to other bids and receive 100% of their Priority bid. This means that no shareholders will suffer dilution from the issue of new shares if they are willing to pay the bookbuild price. In the event that total bids exceed total allocations, shareholders will receive a higher allocation, as a percentage of their bids, than non-shareholders.

An example list of bids is provided below:
Shareholder A owns 5% of ListCo and bids 95 c for 5% of the new shares to be issued (ie 5 million shares);
Shareholder B owns 4% of ListCo and bids 95 c for 5% of the new shares to be issued (ie 5 million shares);
Shareholder C owns 3% of ListCo and bids 94 c for 5% of the new shares to be issued (ie 5 million shares);
Investor D does not own ListCo and bids 95 c for 5% of the new shares to be issued (ie 5 million shares); and
Investor E does not own ListCo and bids 95 c for 5% of the new shares to be issued (ie 5 million shares).

Shareholders A, B, C and Investor E are not clients of the TLM. Additionally, Investor D is a client of the TLM.

Under a traditional placement, only the clients of the TLM would be invited to bid (i.e. only investor D). Other shareholders, such as Shareholder C, may not be invited, or permitted, to bid into the bookbuild for the new securities.

In this example, at the final bookbuild price of 95 c there is 150 million of cumulative bids at or above 95 c. As there is only to be 100 million shares issued, if all bids were treated equally, then each bidder would receive 66% of their bid (ie 100/150), and Shareholders A, B and C would be diluted. However, in this example, these shareholders can enter their bids via their usual third party broker along with their unique shareholder identifier.

The automated allocation system executed by the host processing system calculates and determines allocations automatically as follows:
Shareholder A is entitled to Priority Status for 5% of the issue, or 5 million shares.
Shareholder A receives allocations of shares for 100% of its bid, and is not diluted;
Shareholder B is entitled to Priority Status for 4% of the issue, or 4 million shares.
Shareholder B receives allocations of 4 million shares, and therefore its shareholding not diluted. The 1 million balance is treated as a non-priority bid.
Shareholder C had bid below the final match price, and does not receive any allocation. Investor D is a client of the TLM, and the TLM and ListCo agree that it is in the interests of ListCo for Investor D's bid to be all entered as a Priority Bid by the TLM, who has the capacity to enter bids as Priority Bids or market bids. As a Priority Bidder, Investor D receives an allocation of 100%, or 5 million shares.
As Investor E is neither a shareholder, nor a client of the TLM, its bids are treated as on-market bids. As there is 150 million of bids, and only 100 million shares to be allocated, and shareholders that have bid with their unique identifier are allocated first, there will be significant scale-back of Investor E's bids.

This process ensures that shareholders receive a priority status in a contestable price bookbuild without having a relationship with the TLM. Previously, either pricing was not contestable in a rights issue, and each shareholder was sent communications directly from the company, or pricing was contestable by way of a placement, but each shareholder would only have a allocation if they were to have, or arrange, a contractual relationship with the lead manager. This process additionally brings together both the benefits of a rights issue (pre-emptive and proportional rights) with the benefits of a placement (price contestability). The company will be able to see how many of its shareholders will be allocated at each price point, and weigh the benefits of receiving increased proceeds from the issue versus the benefits of allocating to shareholders, or identified new investors, and having regard to the total scale back.

Continuing with this example, the TLM can additionally store in the priority identifier data unique identifiers for each customer of ListCo, and a percentage or number of shares over which that customer will receive priority. ListCo can advise each customer of its unique identifier and of their individual priority allocation, so that they are incentivised to bid.

In another example, certain bidders, such as shareholders, are provided the right to increase their priority to a specified level of priority, but where the number of securities that will be allocated in priority relates to less than 100% of that amount. This could be used to ensure that a minimum number, or percentage, of securities are available for new bidders and not subject to a pre-emptive right. This advantageously enables new bidders (i.e. non-shareholders) motivation to bid. If the minimum amount of securities that could be issued to new investors is zero, then new investors may not be inclined to bid. However, if the level of priority is restricted to 80% of shareholders' bids, then at least 20% of the offer can be made available to new investors.

It should be appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

The present invention, in various embodiments, may take the form of a computer-implemented method, system, processor, computer-readable storage medium having computer-executable instructions, firmware, or an embodiment combining software and hardware aspects.

Although a preferred embodiment has been described in detail, it should be understood that various changes, substitutions, and alterations can be made by one of ordinary skill in the art without departing from the scope of the present invention.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

What is claimed is:

1. A computer-implemented method of pricing and allocating identified securities of a company, the method performed by at least one computer and comprising:
allocating a unique trading code for the identified securities which are the subject of a bookbuild on a registered securities exchange;
receiving, by the at least one computer which is associated with the registered securities exchange, bid data indicative of bids by eligible investors for at least some of the identified securities;
determining, by the at least one computer, a match price for the identified securities after receiving at least some of the bid data; and
determining, by the at least one computer, a preferential allocation of at least some of the identified securities to at least some of the eligible investors at least partially based on bids that are higher than the determined match price;
wherein, the preferential allocation of at least some of the identified securities to at least some of the eligible investors is part of the bookbuild that is performed on the registered securities exchange.

2. The computer-implemented method as claimed in claim 1, wherein the preferential allocation is determined at least partially using a Price Leader's Allocation parameter.

3. The computer-implemented method as claimed in claim 1, wherein the match price is limited to a maximum match price specified by an issuer of the identified securities.

4. The computer-implemented method as claimed in claim 2, wherein the Price Leader's Allocation parameter is a percentage of available securities.

5. The computer-implemented method as claimed in claim 1, wherein the preferential allocation is limited by a preferential allocation cap.

6. The computer-implemented method as claimed in claim 2, wherein the Price Leader's Allocation parameter is variable during the bookbuild.

7. The computer-implemented method as claimed in claim 1, wherein other allocations of at least some of the identified securities are based on determining, by the at least one computer, a priority allocation based on a priority status of a priority bidder.

8. The computer-implemented method as claimed in claim 7, wherein first priority bidders are allocated a first priority allocation and second priority bidders are allocated a second priority allocation.

9. The computer-implemented method as claimed in claim 8, wherein the first priority allocation is 100% of bids by the first priority bidders and the second priority allocation is a variable % of bids by the second priority bidders.

10. The computer-implemented method as claimed in claim 7, wherein the preferential allocation is allocated after the priority allocation.

11. The computer-implemented method as claimed in claim 1, wherein other allocations of at least some of the identified securities are based on determining, by the at least one computer, a pro rata allocation based on bids for a proportion of a number of securities.

12. The computer-implemented method as claimed in claim 11, wherein the preferential allocation is allocated before the pro rata allocation.

13. The computer-implemented method as claimed in claim 7, wherein the preferential allocation is determined, by the at least one computer, using:
surplus bids not filled in the priority allocation that are above the match price; and,
all bids from on-market bidders that are above the match price.

14. The computer-implemented method as claimed in claim 11, wherein the pro rata allocation is determined, by the at least one computer, using:
surplus bids not filled in the priority allocation and preferential allocation that are at or above the match price; and,
all bids from on-market bidders that are at or above the match price.

15. The computer-implemented method as claimed in claim 1, also comprising:
sending, from the at least one computer to at least one client computer system, price data indicative of the match price and allocation data indicative of the preferential allocation.

16. The computer-implemented method as claimed in claim 1, wherein the match price is determined, by the at least one computer, in real time and the bids are able to be accepted in real time by an issuer or seller of the identified securities as part of the bookbuild performed on the registered securities exchange.

17. The computer-implemented method as claimed in claim 1, wherein determining the match price is at least partially based on setting an excess coverage.

18. The computer-implemented method as claimed in claim 1, wherein a Bid Price Limitation parameter is used to limit bids to within a specified range of the match price.

19. The computer-implemented method as claimed in claim 1, wherein a Price Discovery parameter is used to limit bids used to determine the match price to bids within a specified range of the match price.

20. The computer-implemented method as claimed in claim 1, wherein a Price Discoverer's Allotment parameter is used to at least partially allocate the identified securities to bids within a specified range of the match price.

21. The computer-implemented method as claimed in claim 1, wherein an Institutional Buyer Price Discovery Enhancement parameter is used to limit bids that are taken into account for determining, by the at least one computer, the match price and/or allocations.

22. The computer-implemented method as claimed in claim 1, wherein a Lottery Allocation parameter is used to randomly allocate at least some of the identified securities.

23. The computer-implemented method as claimed in claim 1, wherein a holding lock is used to prevent at least some securities from being sold for a period of time after being allocated under the bookbuild.

24. The computer-implemented method as claimed in claim 1, wherein other allocations of at least some of the identified securities are based on determining, by the at least one computer, a time-based allocation at least partially based on timing of submission of a bid.

25. The computer-implemented method as claimed in claim 24, wherein a bidder who submits a bid prior to a specified or relative time is eligible to receive a time-based allocation.

26. The computer-implemented method as claimed in claim 24, including multiple specified time stages having different time-based allocations based on timing of submitting bids.

27. The computer-implemented method as claimed in claim 1, wherein other allocations of at least some of the identified securities are based on determining, by the at least one computer, a further pro rata based allocation for bids participating in a final allocation stage.

28. The computer-implemented method as claimed in claim 27, wherein the final allocation stage is for bids from one or more underwriters.

29. The computer-implemented method as claimed in claim 1, wherein the identified securities are existing securities and the method is for a buy-back of the existing securities.

30. The computer-implemented method as claimed in claim 1 including:
identifying, by the at least one computer and based on received data, at least one of the eligible investor's bids associated with a priority status; and
determining, by the at least one computer, the preferential allocation for at least some of the at least one eligible investor's bid based on the identified priority status.

31. The computer-implemented method as claimed in claim 30, wherein the at least one computer has access to priority identifier data indicative of:
one or more identifiers indicative of the at least one of eligible investor; and
the associated priority status;
wherein the method includes:
receiving, by the at least one computer, one of the bids having associated therewith the unique identifier for the at least one eligible investor; and
determining the priority status for the at least one eligible investor using the received unique identifier and the priority identifier data.

32. The computer-implemented method as claimed in claim 31, wherein each priority status stored in the priority identifier data has associated therewith a priority factor for determining the preferential allocation, wherein the priority factor is defined by or on behalf of the company.

33. The computer-implemented method as claimed in claim 31, wherein the one or more identifiers are one or more shareholder identifiers indicative of one or more current shareholders of the company.

34. A host computer system for pricing and allocating identified securities of a company, comprising:
at least one processor to associate a unique trading code with the identified securities which are the subject of a bookbuild on a registered securities exchange; and,
an input device to receive bid data indicative of bids by eligible investors for at least some of the identified securities;
wherein, the at least one processor determines a match price for the identified securities after receiving at least some of the bid data, and a preferential allocation of at least some of the identified securities to at least some of the eligible investors at least partially based on bids that are higher than the determined match price, and wherein the preferential allocation of at least some of the identified securities to at least some of the eligible investors is part of the bookbuild that is performed on the registered securities exchange.

35. A computer-readable storage medium having computer-executable instructions for pricing and allocating identified securities of a company, the computer-executable instructions that when executed by at least one computer are configured to:
associate a unique trading code for the identified securities which are the subject of a bookbuild on a registered securities exchange;
receive bid data indicative of bids by eligible investors for at least some of the identified securities;
determine a match price for the identified securities using at least some of the bid data; and
determine a preferential allocation of at least some of the identified securities to at least some of the eligible investors at least partially based on bids that are higher than the determined match price;
wherein the preferential allocation of at least some of the identified securities to at least some of the eligible investors is part of the bookbuild that is performed on the registered securities exchange.
